(19) United States
(12) Patent Application Publication
(10) Pub. No.: US 2015/0134388 A1
(43) Pub. Date: May 14, 2015

(54) METHODS AND SYSTEMS FOR PROVIDING, BY A REFERRAL MANAGEMENT SYSTEM, DYNAMIC SCHEDULING OF PROFILED PROFESSIONALS

(71) Applicant: Kyruus, Inc., Boston, MA (US)

(72) Inventors: Julie Keunhee Yoo, Boston, MA (US); Vinay Seth Mohta, Newton, MA (US); Graham Stewart Gardner, Sudbury, MA (US)

(21) Appl. No.: 14/537,115

(22) Filed: Nov. 10, 2014

Related U.S. Application Data
(60) Provisional application No. 61/902,871, filed on Nov. 12, 2013.

(51) Int. Cl. G06Q 10/06; G06Q 10/10

(52) U.S. Cl. CPC G06Q 10/063112; G06Q 10/1095
USPC 705/7.14

(57) ABSTRACT

A method for matching a professional with a referral opportunity includes automatically generating, by a profile generator executing on a first computing device, a profile of a professional. The method includes receiving, by an analysis engine executing on the first computing device, from a second computing device, an identification of a referral opportunity having at least one requirement. The method includes determining, by the analysis engine, that the generated profile satisfies the at least one requirement. The method includes transmitting, by the analysis engine, to the second computing device, the identification of the professional. The method includes receiving, by the first computing device, an indication that a user of the second computing device made a referral to the professional. The method includes scheduling, by a workflow engine executing on the first computing device, an appointment with the professional for a subject of the referral opportunity.

### CROSS-REFERENCE TO RELATED APPLICATIONS

This application claims priority from U.S. Provisional Patent Application No. 61/902,871, filed on Nov. 12, 2013, entitled “Methods and Systems for Profiling Professionals, for Dynamic Scheduling of Profiled Professionals, and for Case Management by Profiled Professionals,” which is hereby incorporated by reference.

### BACKGROUND

The disclosure relates to profiling professionals. More particularly, the methods and systems described herein relate to providing, by a referral management system, dynamic scheduling of profiled professionals.

Conventionally, professionals' profiles are used for many purposes including, for example, identifying industry opportunities for professionals, or identifying key opinion leaders. Existing approaches to generating profiles and identifying opportunities or professionals are typically manual or driven by secondary variables. Manual approaches may be time-consuming (for example, cold-calling providers and asking for suggestions). Additionally, typical technologies tend to be unable to keep up with the velocity, volume, and variety of data required to populate professional profiles.

Conventional methods of generating referrals between professionals typically depend on intuition and the limitations of the referring professional, as opposed to bias-free, data-driven identification of professionals accepting referrals while also conforming to the constraints associated with a subject of the referral.

### BRIEF SUMMARY

In one aspect, a method for providing, by a referral management system, dynamic scheduling of profiled professionals includes automatically generating, by a profile generator executing on a first computing device, a profile of a professional. The method includes receiving, by an analysis engine executing on the first computing device, from a second computing device, an identification of a referral opportunity having at least one requirement. The method includes determining, by the analysis engine, that the generated profile satisfies the at least one requirement. The method includes transmitting, by the analysis engine, to the second computing device, the identification of the professional. The method includes receiving, by the first computing device, an indication that a user of the second computer made a referral to the professional. The method includes scheduling, by a workflow engine executing on the first computing device, an appointment with the professional for a subject of the referral opportunity.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2 is a block diagram depicting one embodiment of a system for profiling a professional, matching a professional with a referral opportunity, associating a professional with a category of expertise, and case management by a referring professional;

FIG. 3A is a flow diagram depicting an embodiment of a method for generating a profile for a professional, matching the professional with a referral opportunity, and recording the referral in a profile of the professional;

FIG. 3B is a screen shot depicting one embodiment of profiles generated by a profile generator;

FIG. 3C is a screen shot depicting one embodiment of a description of a level of expertise for each of a plurality of profiled professionals;

FIG. 3D is a screen shot depicting an embodiment of a description of a level of expertise for each of a plurality of profiled professionals;

FIG. 3E is a flow diagram depicting an embodiment of a method for matching a professional with a referral opportunity;

FIG. 3F is a flow diagram depicting an embodiment of a method for determining clinical effectiveness based on workload;

FIG. 3G is a block diagram depicting one embodiment of a data structure generated by an analysis engine and storing determined calculations;

FIG. 4 is a flow diagram depicting one embodiment of a method for associating a professional with a category of expertise;

FIG. 5A is a flow diagram depicting one embodiment of a method for matching a professional with a referral opportunity and scheduling an appointment with the professional for a subject of the referral opportunity;

FIG. 5B is a flow diagram depicting one embodiment of a method for matching a professional with a referral opportunity, scheduling an appointment with the professional for a subject of the referral opportunity, and automatically reserving a resource required for the appointment; and

FIG. 6 is a flow diagram depicting one embodiment of a method for case management by a referring professional.

### DETAILED DESCRIPTION

In some embodiments, the methods and systems described herein profile professionals and entities, generate referrals for profiled professionals, and dynamically schedule appointments with the referred, profiled professionals on behalf of a subject of the referrals. Before describing such methods and systems in detail, however, a description is provided of a network in which such methods and systems may be implemented.

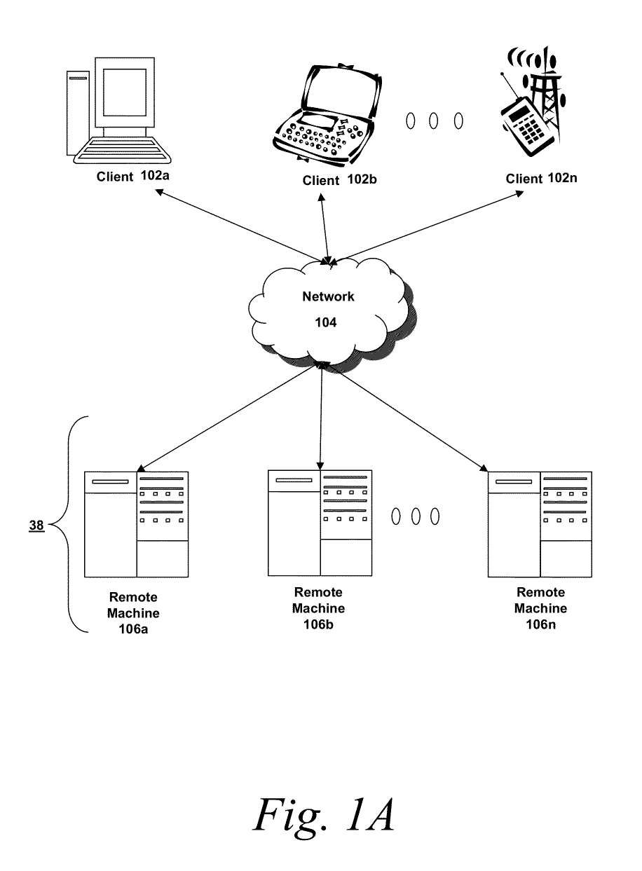

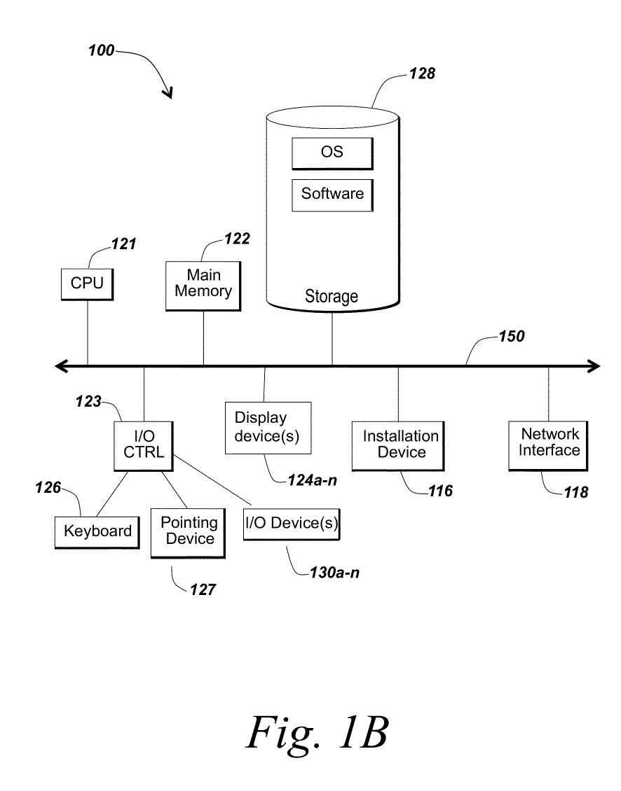

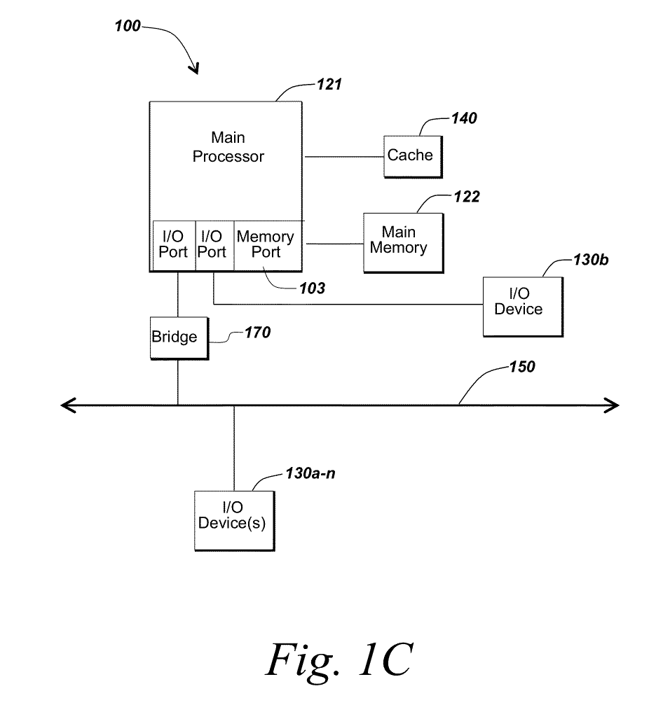

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash.; the Oracle iPlanet web server products provided by Oracle Corporation of Redwood Shores, Calif.; or the BEA WEBLOGIC products provided by BEA Systems of Santa Clara, Calif.

In some embodiments, the system may include multiple, logically grouped, remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch disks, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, of which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd., of Seoul, Korea; Nokia of Finland; Hewlett-Packard Development Company, L.P. and/or Palm, Inc., of Sunnyvale, Calif.; Sony Ericsson Mobile Communications AB of Lund, Sweden; or Research In Motion Limited, of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc. of Cupertino, Calif. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J.; Motorola Inc. of Schaumburg, Ill.; or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the iPad line of devices manufactured by Apple Inc.; the PlayBook manufactured by Research in Motion; the Cruz line of devices manufactured by Velocity Micro, Inc. of Richmond, Va.; the Folio and Thrive line of devices manufactured by Toshiba America Information Systems, Inc. of Irvine, Calif.: the Galaxy line of devices manufactured by Samsung; the HP Slate line of devices manufactured by Hewlett-Packard; and the Streak line of devices manufactured by Dell, Inc. of Round Rock, Tex.

In some embodiments, the disclosed method and system automatically generate professional profiles and match the generated profiles to referral opportunities. In some embodiments, each profile describes a wide range of professional skills, by collecting, analyzing, and continuously updating data concerning professional development, credentials, influence, connections, and peer recognition. In some embodiments, the volume and complexity of the analyzed data allows the disclosed system to match professionals to opportunities optimally and to proactively schedule professionals with referrals. The richness of the profile is further enhanced by the dynamic and automatic collection of updated information from various sources of electronic data, such as clinical systems and administrative systems.

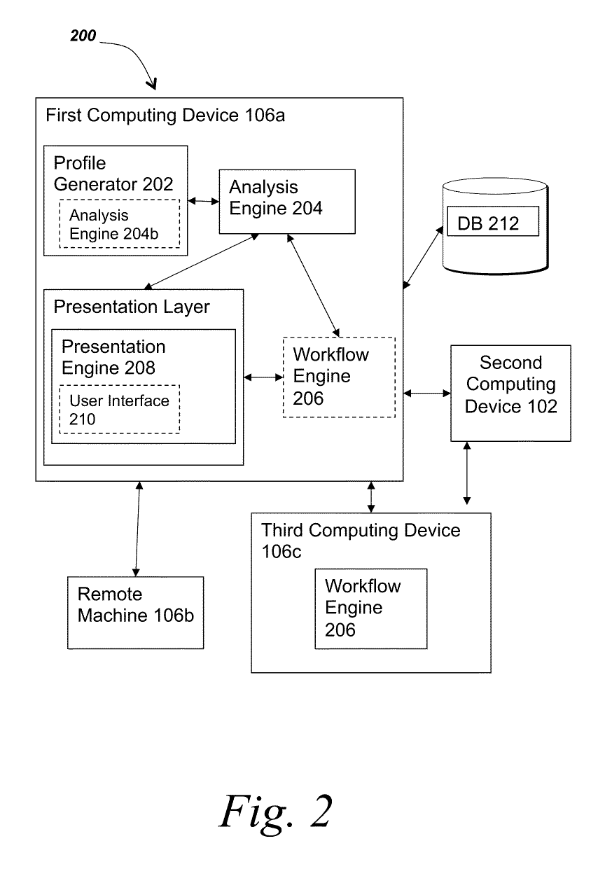

Referring now to FIG. 2, a block diagram depicts one embodiment of a system for profiling at least one of a professional and an entity. In brief overview, the system includes a second computing device 102, remote machines 106a-c, a profile generator 202, an analysis engine 204, a workflow engine 206, and a presentation engine 208. In some embodiments, the profile generator includes a second analysis engine 204b.

The profile generator 202 automatically generates a profile of at least one of a professional and an entity. In some embodiments, the profile includes at least one identification of a professional connection of the at least one of the professional and the entity. In other embodiments, the profile includes at least one lifestyle characteristic of a professional. The profile may also include areas of expertise.

The analysis engine 204 analyzes the generated profile. The analysis engine 204 determines, responsive to the analysis, a level of expertise of a professional in an industry. In some embodiments, a profiled individual or entity has a level of domain expertise. In some embodiments, a level of expertise refers to a level of familiarity with a particular subject. The analysis engine 204 determines, responsive to the analysis, a category of expertise, in some embodiments, as set forth more fully below. In other embodiments, the analysis engine 204 determines a level of influence. For example, the analysis engine 204 may determine that a profiled individual or entity has a level of influence over one or more other individuals or entities based, at least in part, on the level of expertise the profiled individual or entity has in a particular industry or domain. In one embodiment, a level of expertise refers to one or more internal factors—factors specific to, or internal to, a profiled professional—while a level of influence refers to one or more external factors—factors independent of the professional and relating to the professional's interactions with others. Examples of factors considered in establishing levels of expertise include numbers of articles, numbers of grants, levels of involvement in particular organizations and a number of organizations with which the individual interacts (e.g., a number of interactions an academic has with a professional in industry or vice versa). Examples of factors considered in establishing levels of influence include external factors associated with a profiled professional, such as a reporting structure relative to another professional or a professional connection such as a mentoring, training or other connection between the profiled professional and a second professional. In other embodiments, a level of influence refers to a degree of reach of a professional or for how long the professional influences others' behaviors. In further embodiments, the analysis engine 204 determines both a level of expertise and a level of influence. The analysis engine 204 transmits, to a second computing device, an identification of the determined level of expertise.

In one embodiment, the professional is a medical professional. For example, the professional may be any kind of doctor, a medical student, a nurse, a pharmacist, or a healthcare professional. In another embodiment, the professional is an individual working in a professional services environment such as, without limitations, a lawyer, a consultant, real estate professional, or financial services professional (e.g., accountants and bankers). In some embodiments, a professional provides support services to other professionals in an industry. For example, an industry professional may be a sales person selling pharmaceutical products to doctors or a jury consultant assisting litigators with jury selection. In other embodiments, professionals include students (of any discipline), education professionals (teachers, school administrators, etc.), athletes, and politicians.

Referring now to FIG. 2, and in greater detail, the profile generator 202 generates a profile of a professional or an entity. In one embodiment, the profile generator 202 accesses a database 212 to retrieve data associated with the professional or entity. In another embodiment, the profile generator 202 accesses a second remote computing device 106b to retrieve data associated with the professional or entity; for example, the profile generator 202 may query a remotely located database or computer. In still another embodiment, the profile generator 202 accesses a second remote computing device 106b to identify a professional or entity for whom to generate a profile. The remote computing device 106b may be owned, operated, or otherwise associated with an entity unaffiliated with the entity implementing the methods and systems described herein.

In some embodiments, the profile generator 202 includes a second analysis engine 204b (depicted in shadow in FIG. 2). In one of these embodiments, the second analysis engine 204b analyzes data retrieved by the profile generator 202. In another of these embodiments, the second analysis engine 204 determines whether to include the analyzed data in the generated profile. In one example, the second analysis engine 204b may include the functionality of the analysis engine 204. In another example, the second analysis engine 204b is a version of the analysis engine 204 that has been customized to include functionality for determining whether to include data in a generated profile. In other embodiments, the profile generator 202 is in communication with a second analysis engine 204b. In further embodiments, the profile generator 202 accesses the analysis engine 204, which makes a determination as to whether to include data in a generated profile.

In some embodiments, the profile generator 202 stores a generated profile in a database 212. In some embodiments, the database 212 is an ODBC-compliant database. For example, the database 212 may be provided as an ORACLE database, manufactured by Oracle Corporation of Redwood Shores, Calif. In other embodiments, the database 212 can be a Microsoft ACCESS database or a Microsoft SQL server database, manufactured by Microsoft Corporation of Redmond, Wash. In still other embodiments, the database 212 may be a custom-designed database based on an open source database, such as the MYSQL family of freely available database products distributed by MySQL AB Corporation of Uppsala, Sweden. In some embodiments, the database 212 is maintained by, or associated with, a third party.

In some embodiments, the profile generator 202 generates a profile for an entire organization; for example, in addition to profiling a professional, the system may generate profiles for companies, academic institutions, professional associations, or other entities. In one of these embodiments, the analysis engine 204 analyzes profiles for individuals within the organization to develop a profile for the organization as a whole. In another of these embodiments, the analysis engine 204 analyzes the organizational profile to generate a level of expertise of the organization. By way of example, a teaching hospital hiring highly qualified doctors and renowned for its work in a particular medical specialty may have a high level of expertise in that industry; such a level of expertise would be relevant to, for example, a medical student seeking to work in the medical specialty, a medical device company seeking to receive the perspective of reputable doctors on a new device, or a patient seeking a certain level of expertise from his or her doctor. In other embodiments, the profile generates a profile for an organization independent of generating a profile for any individual professional affiliated with the organization (e.g., by generating a profile for a hospital without generating profiles for individual employees of the hospital).

The analysis engine 204 analyzes a generated profile, and determines, responsive to the analysis, a level of expertise of the professional in an industry. In one embodiment, the analysis engine 204 includes functionality for retrieving stored profiles from a database 212. In another embodiment, the analysis engine 204 includes functionality for requesting profiles and receiving profiles from the profile generator 202. In still another embodiment, the analysis engine 204 includes functionality for accessing previously analyzed profiles for comparison with a generated profile. In an additional embodiment, the analysis engine 204 includes functionality for accessing payroll records pertaining to the services of the professional who is the subject of the profile. The analysis engine 204 may receive the payroll records from a remote machine 106b; for example a remote machine 106b that maintains payroll records for an institution at which the professional works. In other embodiments, the analysis engine 204 includes functionality for accessing billing records pertaining to the services of the professional who is the subject of the profile. The analysis engine 204 may receive the billing records from a remote machine 106b; for example a remote machine 106b that maintains billing records for an institution at which the professional works. The analysis engine 204 may also include functionality for receiving electronic medical records; in some embodiments, the analysis engine 204 receives electronic medical records from a remote machine 106b that maintains such records.

The analysis engine 204 in some embodiments receives an industry opportunity from a second professional, as set forth in more detail below. Industry opportunities include, by way of example, and without limitation, speaking opportunities, consulting opportunities, employment opportunities, referral opportunities, opportunities to become involved with clinical trials, publication opportunities, and membership opportunities. By way of example, and without limitation, a referral opportunity may be an opportunity to work at a particular hospital or to be hired by a particular patient. In some embodiments, the analysis engine 204 receives a selection from the second professional selecting the first professional for a referral, as set forth in more detail below.

In one embodiment, the system includes a presentation layer that provides user-facing context to the analytics. In another embodiment, the presentation layer provides user-generated data back to the profile generator 202, creating an interactive feedback loop of user-generated data. The presentation layer may include a presentation engine 208, which executes to provide at least one user interface. In some embodiments, the end user may access a user interface generated by the presentation engine 208 in order to generate queries; for example, the end user may make requests for identifications of professional profiles or requests for identifications of individuals who satisfy requirements for industry opportunities, via the presentation engine 208, which may be provided as a web site including at least one user interface with which the end user may submit queries. In some embodiments, the presentation engine 208 generates a user interface 210 that enables the second professional to view an identification of a level of progress of the professional in interacting with a subject of a referral, as set forth more fully below.

The system 200 may include a workflow engine 206. In one embodiment, the workflow engine 206 maintains a state for one or more processes managed by the remote machine 106a. For example, the workflow engine 206 may record a status of a profile being analyzed by the analysis engine 204. As another example, the workflow engine 206 may record a status indicating that the analysis engine 204 has generated a recommendation of a professional profile to transmit to a first professional in connection with an industry opportunity managed by a second professional but note that the second professional has not yet contacted the first professional. In embodiments in which the machine 106a provides scheduling resources facilitating a connection between, for example, a plurality of professionals, the workflow engine 206 may record a status of the scheduling process. In embodiments in which the machine 106a provides functionality facilitating an authorization of a connection between a professional and a client (e.g., by confirming that an insurance company authorizes an appointment between a physician and a patient), the workflow engine 206 may record a status of the authorization process. In embodiments in which the machine 106a provides functionality facilitating generation and transmission of customized disclosure reports on behalf of a professional, the workflow engine 206 may record a status of a customized disclosure report as the customized disclosure report is, for example, generated, approved for transmission, and filed with the appropriate entity. In some embodiments, the workflow engine 206 provides status reports to other components executing on, or in communication with, the machine 106a. In other embodiments, the workflow engine 206 provides status reports to other computing devices, such as, for example, the second computing device 102 and the remote machine 106b. In some embodiments, the workflow engine 206 schedules an appointment for a professional with the subject of a referral opportunity. The workflow engine 206 may also reserve resources for an appointment that it schedules.

The profile generator 202, analysis engine 204, workflow engine 206 and presentation engine 208 may operate on one or more computing devices in various combinations. For instance, in some embodiments, the profile generator 202, analysis engine 204 and presentation engine 208 operate on a first computing device 106a and the workflow engine 206 executes on a third computing device 106c; in other embodiments, the third computing device is the same device as the first computing device 106a, such that the workflow engine 206 executes on the same device as the profile generator 202, analysis engine 204, and presentation engine 208. Skilled practitioners in the art will be aware of many other possible combinations of remote devices on which one or more of the profile generator 202, analysis engine 204, workflow engine 206, or presentation engine 208 may operate.

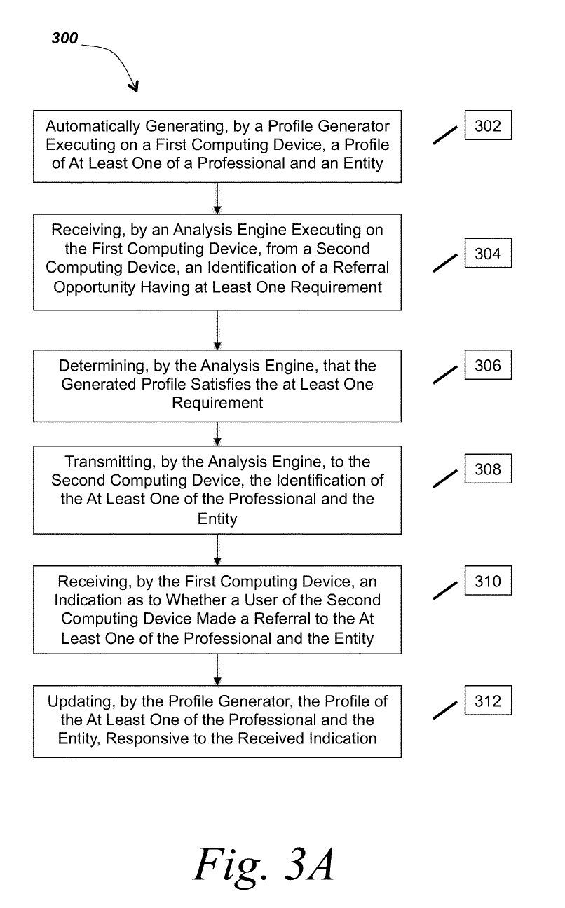

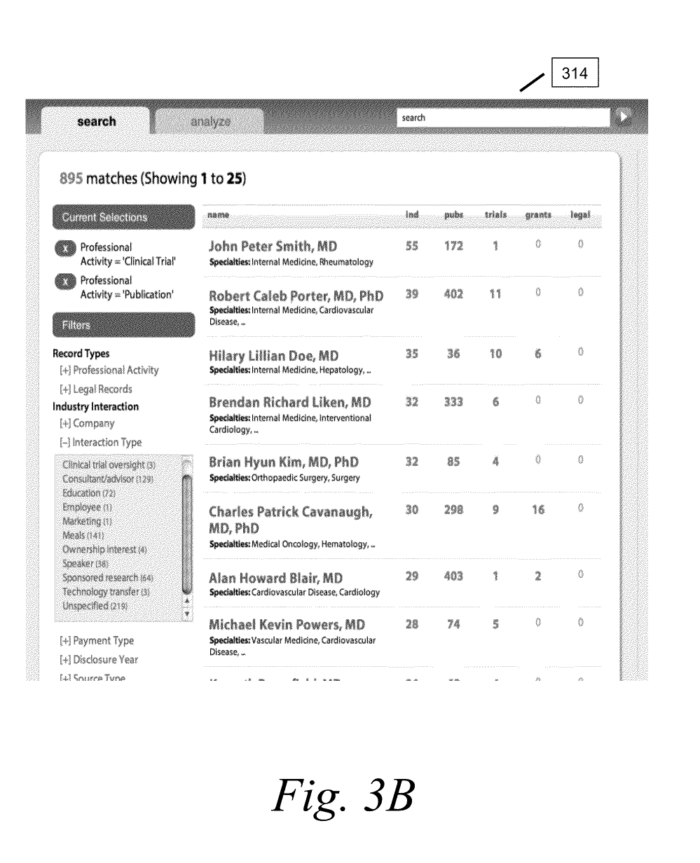

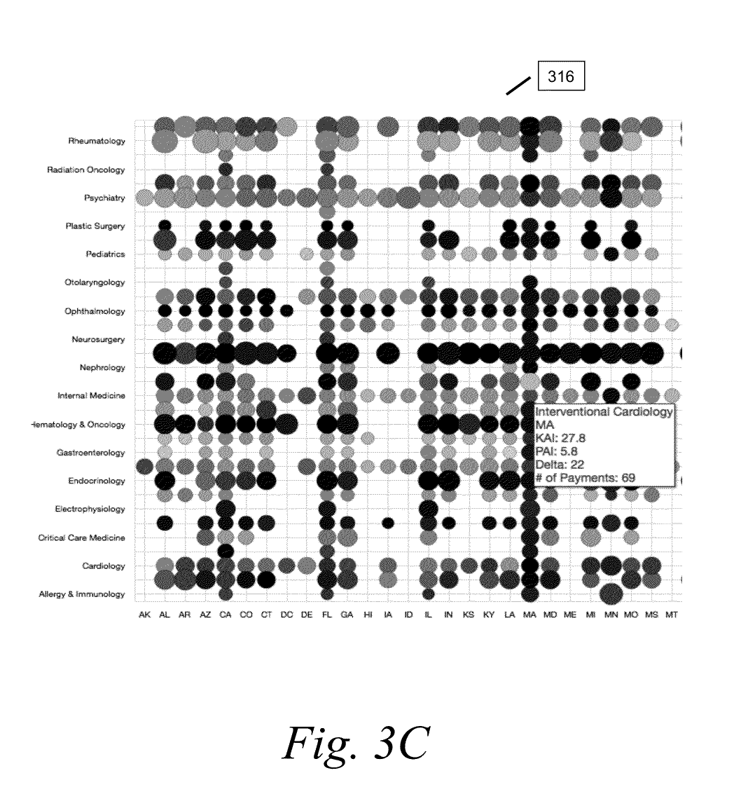

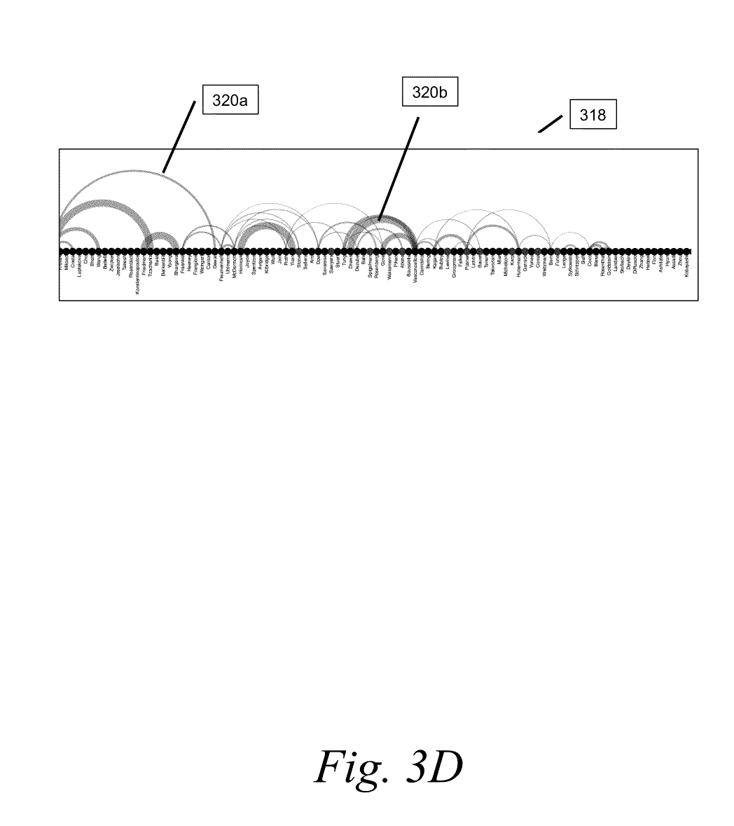

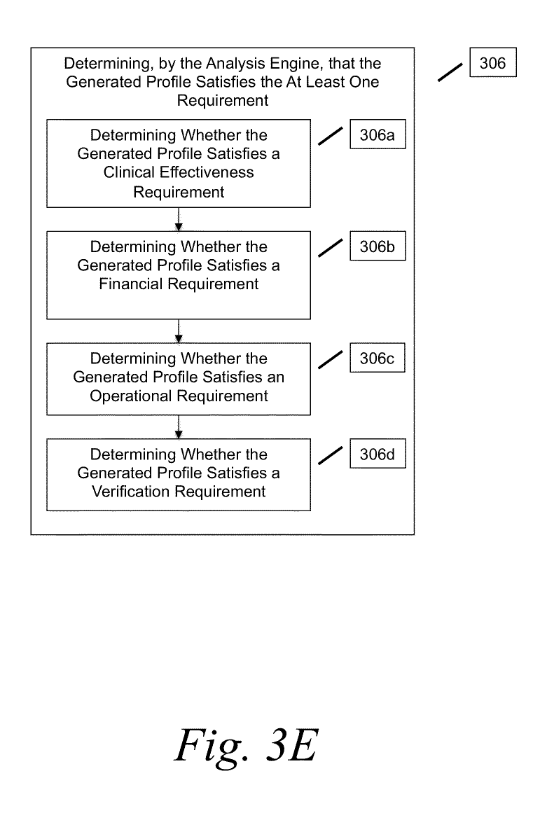

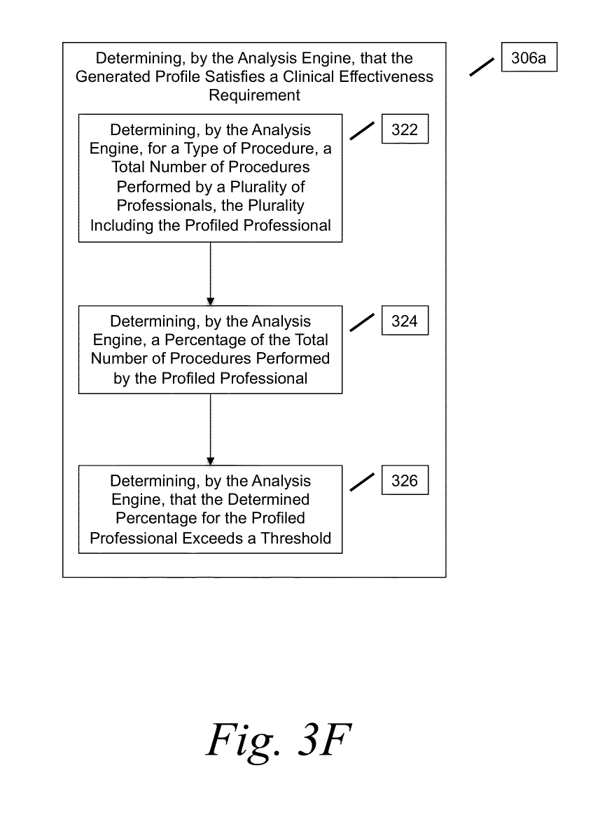

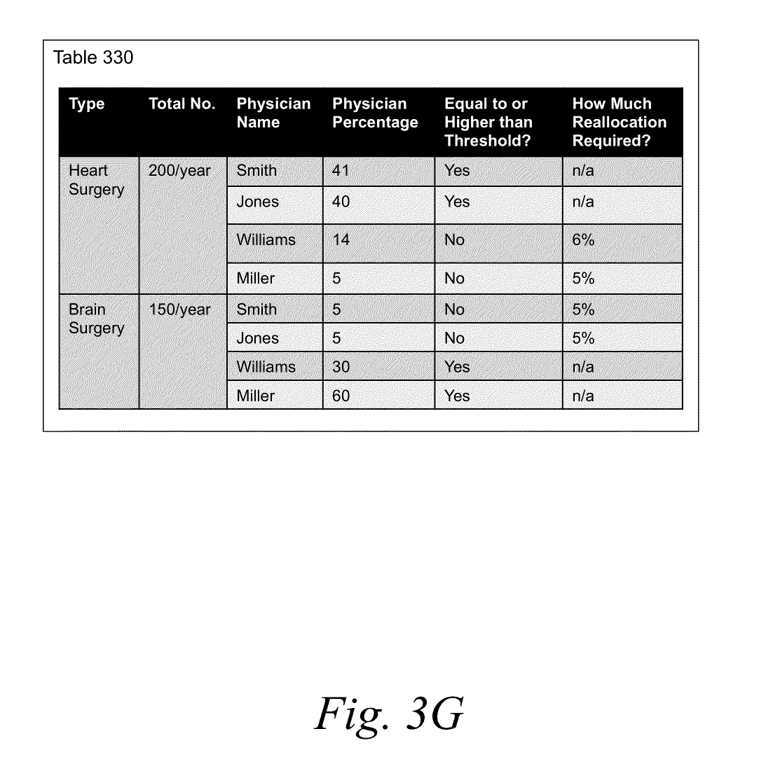

Referring now to FIG. 3A, a flow diagram depicts one embodiment of a method for updating a profile associated with at least one of a professional and an entity. In brief overview, the method includes automatically generating, by a profile generator executing on a first computing device, a profile of at least one of a professional and an entity (302). The method includes receiving, by an analysis engine executing on the first computing device, from a second computing device, an identification of a referral opportunity having at least one requirement (304). The method includes determining, by the analysis engine, that the generated profile satisfies the at least one requirement (306). The method includes transmitting, by the analysis engine, to the second computing device, the identification of the at least one of the professional and the entity (308). The method includes receiving, by the first computing device, an indication as to whether a user of the second computing device made a referral to the at least one of the professional and the entity (310). The method includes updating, by the profile generator, the profile of the at least one of the professional and the entity responsive to the received indication (312).

Referring now to FIG. 3A in greater detail, and in connection with FIG. 2, the profile generator, executing on the first computing device, automatically generates a profile of a profile of at least one of a professional and an entity (302). In one embodiment, the profile generator 202 generates an initial profile of the either the professional or the entity automatically and without any input from the professional or entity. In such an embodiment, the profile generator 202 generates the profile without the professional requesting the generation of the profile and without the professional or entity providing any information to the system. In another embodiment, the profile generator 202 may receive input from the professional or the entity modifying the automatically generated profile; for example, the remote machine 106 may execute a web server displaying a web page from which the professional or an individual associated with the entity can make modifications to the profile after the profile generator 202 generates the profile.

Referring to FIG. 3B, a screen shot depicts one embodiment of profiles generated by the profile generator 202. In one embodiment, a user interface 314 displays a listing of profiled professionals. As shown in FIG. 3B, by way of example, a listing of a profiled professional may include a summary of the professional's specialties, a number of publications by the professional, a number of grants, and a number of trials participated in. As shown in FIG. 3B, the user interface 314 may provide functionality allowing users to search for profiled professionals.

Referring back to FIG. 3A, and in one embodiment, the profile generator 202 accesses local and remote databases to automatically generate the profile. In another embodiment, the profile generator 202 identifies connections the professional or entity has to other professionals or entities—including, for example, co-workers, employers, employees, mentors, mentees, colleagues, co-authors, co-presenters, and vendors. For example, the profile generator 202 may search, without limitation, databases of publications (e.g., journal databases), hospital databases (e.g., to find out where a doctor works), databases of current and former academic faculty (e.g., to find out where someone taught or teaches, or which professors a professional studied under), social media databases, databases of sports club or gym memberships, and databases of alumni (e.g., to determine where the professional went to school). In still another embodiment, the profile generator 202 may search databases including, without limitation, databases storing information relating to demographics, professional writing (publications, etc.), and disciplinary, legal, medical, economic, and credentialing information. In some embodiments, the profile generator 202 accesses primary data. In other embodiments, the profile generator 202 accesses secondary data. In still other embodiments, the profile generator 202 accesses some data directly and some data indirectly, for example, by inferring information or relationships from other data (i.e., inferring the existence of mentoring relationships). In further embodiments, the profile generator 202 accesses user-generated data. In some embodiments, the profile generator 202 accesses publicly available information. In other embodiments, the profile generator 202 accesses proprietary databases.

In some embodiments, the profile generator 202 accesses data including, without limitation, a level of education, an affiliation with an educational institution, a type of profession, an area of specialization within a profession, an identification of a professor, an identification of a mentor, an identification of an employer, publications, presentations, professional affiliations, memberships, types of clients, office buildings, an identification of a colleague, an identification of a geographical area within which the professional works or lives, biographical information, and areas of expertise; data not explicitly associated with a professional attribute of the professional may be referred to as a lifestyle characteristic. In some embodiments, the profile generator 202 accesses user-generated data. In other embodiments, the profile generator 202 accesses interaction data such as what drugs physicians prescribed, what procedures they followed, to whom they refer patients or colleagues, preferences as to brand, and lifecycle data.

In some embodiments, the profile generator 202 analyzes accessed data to determine whether to include the accessed data in a profile. In other embodiments, the profile generator 202 determines whether accessed data is duplicative of data already in the profile. For example, the profile generator 202 may perform entity resolution (e.g., determining that “Doctor J. Reynolds” is the same individual as “Jonathan Reynolds, MD”). In one of these embodiments, the profile generator 202 determines whether accessed data indicates that data already in the profile is no longer current (e.g., obsolete) or has been modified over time. In further embodiments, the profile generator 202 may identify data to include in a profile using a chain of inference. For example, analyzing a professional's name associated with a publication in a well-regarded journal may allow the profile generator 202 to determine that the professional has a particular area of domain expertise; the area of domain expertise and the professional's name may allow the profile generator 202 to perform a search of a database providing additional data relating to the professional (e.g., a license number, membership, employer, or other data).

In some embodiments, the profile generator 202 is not dependent upon self-entry of data. In other embodiments, the profile generator 202 accesses passively collected data to generate a profile. In one of these embodiments, the profiled individual or entity is not aware of the data collection process. In another of these embodiments, the profile generator 202 accesses administrative or clinical systems to generate a profile. By way of example, and without limitation, administrative systems may include billing, operational, or human resources systems. As another example, and without limitation, clinical systems may include electronic medical record systems or case registries.

In one embodiment, the profile generator 202 generates a profile for a professional; for example, and without limitation, the profile generator 202 may generate a profile of a physician. In another embodiment, the profile generator 202 also generates a profile for a provider of a good or service; the profile generator 202 may generate a profile for a diverse set of providers including, by way of example and without limitation, a provider such as a medical device company, a pharmaceutical company, a professional services company, or individuals employed by such companies. In still another embodiment, the profile generator 202 generates an institutional profile. For example, as indicated above, the profile generator 202 may generate a profile for a company, which may include entities of varied corporate structures (for-profit, not-for-profit, non-profit, and charitable organizations generally). In yet another embodiment, the profile generator 202 generates a profile of an opportunity. For example, the profile generator 202 may generate a profile for an opportunity such as a job opportunity (e.g., a potential client looking to hire a professional, an opportunity in a particular industry such as a consulting or speaking opportunity, or an opportunity with an entity seeking to hire a professional on a contract, full-time, or part-time basis).

In one embodiment, the profile generator 202 uses the generated profile to generate a second profile. For example, in generating an entity's profile, the profile generator 202 may incorporate data from profiles associated with employees of the entity. As another example, in generating an individual's profile, the profile generator 202 may incorporate data from profiles associated with direct reports, mentees, mentors, or other profiled individuals. In some embodiments, therefore, the profile includes at least one identification of a professional connection of the profiled individual. In other embodiments, the profile includes at least one identification of a lifestyle characteristic of a profiled individual (e.g., of memberships, hobbies, activities, travel preferences, or other characteristics that may not be related to the individual's profession).

In one embodiment, the analysis engine 204 analyzes the generated profile to identify characteristics indicative of a level of expertise. In some embodiments, the analysis engine 204 analyzes the generated profile to identify characteristics indicative of a level of influence, which, in one of these embodiments, includes a degree of reach of a physician or for how many others the physician has a level of influence or for how long the physician influences others' behaviors. In some embodiments, drivers of influence include publications, grants, patents, referral volume, number of years of experience, degrees of risk, degrees of compliance, and tenure at particular hospitals. In other embodiments, levels of expertise are factors internal to the profiled professional, such as, without limitation, publications, grants, and experience; levels of influence may be factors external to the profiled professional, such as reporting structure or training structure.

In one embodiment, the analysis engine 204 analyzes a network of professionals to which the profiled professional belongs. The analysis engine 204 may identify ways in which the profiled professional stands out from peers in the network of professionals. The analysis engine 204 may identify characteristics that the profiled professional has in common with peers in the network of professionals. The analysis engine 204 may identify professionals in the network who are farther along in their careers than the profiled professional and compare and contrast the two. In some embodiments, the analysis engine 204 may analyze any or all of the data accessed by the profile generator 202 including, but not limited to, information listed above in connection with FIG. 2.

In some embodiments, the analysis engine 204 determines, responsive to the analysis, a level of expertise in an industry of the at least one of the professional and the entity. The analysis engine 204 may, for example, determine that a publication generated by the profiled professional is accessed by a majority of the members of his or her professional network or by influential members of the industry. In some embodiments, the level is provided as a descriptive term or phrase. In other embodiments, the level is provided as a binary value (e.g., “expert” or “not an expert”). In further embodiments, however, the level is not provided as a binary value but as a range based upon—and varying based upon—one or more weights. For example, the analysis engine 204 may be configured to weight certain types of profile data more or less heavily than others and to combine the various weights of various profile data to generate a level of expertise; in generating a profile of a researcher, for example and without limitation, the analysis engine 204 may count a recent publication in a prestigious journal as worth 0.7 points, while only weighing employment with a second tier institution as 0.2 and then combine the two to generate an overall level of expertise as 0.9 (e.g., out of 1.0).

Referring now to FIG. 3C, a screen shot depicts one embodiment of a description of a level of expertise for each of a plurality of profiled professionals. As shown in FIG. 3C, the analysis engine 204 may generate an index 316 of levels of expertise for each of a plurality of professionals; the index may be referred to as an affinity index. The index 316, by way of example, may include listings of specialties or types of professionals and regions in which the professionals work and include an interface with which users may compare levels of expertise of various professionals.

Referring now to FIG. 3D, a screen shot depicts one embodiment of a description of a level of expertise for each of a plurality of profiled professionals. As shown in FIG. 3D, the analysis engine 204 may generate a graphical depiction 318 of the varying levels of expertise of a number of profiled professionals. As an example, the graphical depiction 318 may include a line 320 connecting two professionals to indicate a connection and may use a characteristic of the line 320, such as a width of the line 320, to indicate a level of expertise the professionals have on each other. By way of example, line 320a is a much thinner line than line 320b and, in one embodiment, this may indicate that the professionals connected by line 320a are not as influential on one another as the professionals connected by line 320b.

In some embodiments, the profile generator 202 dynamically updates the profile to reflect changes to the data underlying the profile. The profile may include information that is likely to change frequently or continuously; such information may be referred to as a dynamic attribute. The information may include the availability of the profiled professional. For instance, for a medical provider such as a physician, the date, time, location, or type of appointment that can be scheduled may change every time the provider modifies her schedule or has a new entry added to the schedule by an automated process as described in further detail below. Likewise, the availability of additional resources relevant to a particular type of appointment, such as additional personnel or special equipment, may change each time the profiled provider or other providers schedule the use of the additional personnel or special equipment; the availability of equipment may be further affected by scheduled maintenance, unexpected repairs, or the need to replace non-reusable components of the equipment.

As an additional example, where the profile of a professional includes clinical fluency data as set forth in further detail below, information concerning the recent activity of the professional, such as how many times the professional has completed a particular kind of procedure recently, may continuously change. Similarly, the schedule load of the professional, or how many times the professional has been scheduled to perform a particular procedure in the near future, may change dynamically as the result of scheduling activity. In. some embodiments, a medical provider's appropriateness to see patients with certain conditions may change over time; for instance, the analysis engine 204 may determine that a provider is unable to see a patient having a particular condition due to a change in clinical fluency or patient outcome information. The medical provider may be unable to accept new patients owing to the schedule flexibility necessary to attend to current patients. In other embodiments, financial constraints, such as the coverage of a particular procedure by a particular insurance carrier, may change.

In some embodiments, the profile generator 202 updates dynamically changing data in the profile by querying and analyzing data from a plurality of sources of information. In one of these embodiments, keeping profile data updated allows the system to use gathered data effectively when seeking optimal matches satisfying multiple constraints. However, each of the plurality of sources may have one or more constraints or limitations that the system needs to consider when balancing the accuracy and timeliness of the dynamic attributes. Examples of limitations include an ability to acquire large amounts of data quickly (e.g., retrieving a year's worth of scheduling data for each of thousands of providers may take several hours on some systems), a level of completeness of the data (e.g, whether provider scheduling data is reported to the information source being polled), and a type of identifier used by each information source (e.g., information from different systems may not identify a profiled professional using the same identifier, or key). Therefore, the profile generator may select a particular technique to form a particular query based upon characteristics of one or more of the plurality of information sources. By way of example, and without limitation, the profile generator 202 may determine to download and update a set of information for all or a majority of professionals at one time (e.g., nightly updates), may determine to download and update a set of information for a subset of professionals at a second time (e.g., hourly updates for professionals who exhibit a high frequency of modifications to associated scheduling data), and may determine to subscribe to a notification system and update profile data as soon as a notification of a change is received (e.g., accept a Health Level 7 (HL7) feed from a scheduling system to receive booking and cancellation notifications).

As an additional example, the profile generator 202 may use frequent queries or a continuous feed to receive immediate updates concerning the schedule of each provider over a short term, such as days or weeks, while using a nightly batch to retrieve longer term schedule information, such as each medical provider's schedule over the ensuing year. The profile generator 202 may select the query approach to use when updating a particular kind of data based on the speed with which that kind of data has updated in the past; for instance, if the availability of a particular professional tends to change slowly, the profile generator 202 may cease frequent queries or feed subscriptions concerning that professional's availability, and rely instead on updates to the availability data in a nightly batch. The profile generator 202 may similarly use stored rules based on the likely behavior of different categories of data to govern the approach used in updating each category of data; the profile generator 202 may modify such rules based on the historical behavior of data as described above.

In other embodiments, a particular data source may have a tendency to make erroneous updates to its data; the profile generator 202 may respond by comparing the data from two consecutive queries to detect and eliminate errors. Likewise, a particular data source may tend to have incomplete data, owing to irregular updates to that data, or a lack of compliance with reporting protocols by staff associated with that data source; as a result, the profile generator 202 may flag the data from that source in a profile as potentially incomplete or out-of-date.

In some embodiments, the use of multiple categories of data concerning a professional to determine skill sets, areas of expertise, and levels of expertise produces an unexpected increase in accuracy for predictions of performance by the profiled professional. Because the analysis of a greater volume of collected data can rely not only on the additional data, but also on the interactions of the additional data with other collected data, the degree of accuracy of the profile may increase faster than a linear function of the additional data collection. The variability of sources of collected data and continued collection of the data over time may enhance that accuracy further.

The method includes receiving, by an analysis engine executing on the first computing device, from a second computing device, an identification of a referral opportunity having at least one requirement (304). The first computing device 106a may execute, for example, a web server displaying a web page from which the industry professional may submit referral opportunities. In another embodiment, the analysis engine 204 receives the identification of the referral opportunity from a second computing device 102 operated by the referring physician. In still another embodiment, the analysis engine 204 receives the identification of the referral opportunity from a remote machine 106b associated with a third-party entity such as, without limitation, a hospital, insurance company, business, or other entity seeking to hire or refer business to a profiled professional satisfying a requirement of the referral opportunity. As described above, industry opportunities include a variety of types of opportunities, including referral and employment opportunities.

In some embodiments, the analysis engine 204 may receive the identification of the referral opportunity from the second computing device 102 associated with a first healthcare professional. As another example, the analysis engine 204 may receive, from a second computing device 102 associated with a first healthcare professional, an identification of an opportunity for a second healthcare professional (e.g., an opportunity for a first doctor to refer a patient to a second doctor). In one of these embodiments, therefore, the analysis engine 204 receives, from the second computing device 102, an identification of a referral opportunity having at least one requirement. In another of these embodiments, the analysis engine 204 receives, from the second computing device 102, an identification of an employment opportunity having at least one requirement. In still another of these embodiments, the analysis engine 204 receives, from another machine, such as a remote machine 106b associated with a hiring organization (e.g., a hospital, university, company, or other entity), an identification of an employment opportunity having at least one requirement.

The identification of the referral opportunity may specify one or more requirements. For example, and without limitation, the identification may specify that a first doctor will only refer a patient to a second doctor if the second doctor specializes in a particular area of medicine, has a particular success rate in performing a type of medical procedure, accepts patients covered by a particular insurer, or is employed by a particular healthcare organization. As another example, and without limitation, the identification may specify that a first doctor will only recommend a second doctor for a job if the second doctor specializes in a particular area of medicine, has a particular success rate in performing a type of medical procedure, accepts patients covered by a particular insurer, or has a particular level of expertise.

In some embodiments, the first computing device 106a includes business logic (including pre-configured business rules that may be, for example, specific to a particular referring professional or organization) for determining whether the generated profile satisfies the at least one requirement. In other embodiments, the first computing device 106a provides a user interface allowing a referring professional to generate and transmit search queries to the first computing device 106a in order to refer a subject of a referral opportunity to a qualified professional.

The method includes determining, by the analysis engine, that the generated profile satisfies the at least one requirement (306). In one embodiment, the analysis engine 204 analyzes a characteristic of the profile of the professional or of the entity to determine whether the generated profile satisfies the at least one requirement. In some embodiments, the analysis engine 204 accesses the affinity index described above in connection with FIG. 3C in determining that the generated profile satisfies the at least one requirement. In other embodiments, the analysis engine 204 applies weights to one or more professional connections of the profiled professional or entity based on the relevance of attributes to the requirements (so that, for example, relevance changes based on the nature of the requirements). In further embodiments, the analysis engine 204 may access claims data in making the determination.

In one embodiment, the analysis engine 204 receives an identification of a diagnosis. For example, an individual associated with the second computing device 102 may accesses the first computing device 106a and provide, via a user interface made available by the first computing device 106a, an identification of a referral opportunity and an identification of a diagnosis of a patient associated with the referral opportunity. For instance, a referring physician (independently or in collaboration with one or more staff members) may visit with a patient, diagnose the patient with a particular illness or condition, determine a need to refer the patient to a second physician (e.g., a specialist in working with patients with the diagnosed condition), and generate a description of the referral opportunity, of the patient, and of the diagnosis. In another embodiment, in which a first individual has contacted an organization associated with a plurality of physicians and requested assistance with a condition, a second individual associated with the organization (e.g., a staff member) may determine that the first individual should be referred to a primary care physician, specialist, or other healthcare professional and generate a request for identification of an appropriate physician with which to connect the first individual. For example, a first individual may contact a hospital (either in person or via telephone or electronic communications) and request access to a doctor to treat a condition; a staff member interacting with the first individual may transmit a request to the remote machine 106a for an identification of a physician able to see the first individual in connection with the condition. In another embodiment, the analysis engine 204 makes an identification of a profiled professional qualified to accept the referral opportunity based upon the received information (e.g., the identification of the referral opportunity, an identification of a diagnoses, and at least one requirement of the referral opportunity) and an analysis of one or more professional profiles.

Referring ahead to FIG. 3E, a flow diagram depicts an embodiment of the method described in connection with FIG. 3A. As shown in FIG. 3E, the method includes determining, by the analysis engine 204, that the generated profile satisfies the at least one requirement of the referral opportunity; the determination may include several sub-determinations before the analysis engine 204 concludes, based on the analyses, that a particular professional is qualified for a particular referral opportunity. As depicted in FIG. 3E, determining that the generated profile satisfies the at least one requirement may include determining whether the generated profile satisfies a clinical effectiveness requirement (306a). Determining that the generated profile satisfies the at least one requirement may include determining whether the generated profile satisfies a financial requirement (306b). Determining that the generated profile satisfies the at least one requirement may include determining whether the generated profile satisfies an operational requirement (306c). Determining that the generated profile satisfies the at least one requirement may include determining whether the generated profile satisfies a verification requirement (306d). Alternative embodiments of determining that the generated profile satisfies the at least one requirement (306) may include making a sub-set (e.g., some, all or none) of the determinations described in connection with FIG. 3E; in other words, the analysis engine 204 may determine that the generated profile satisfies each of a plurality of requirements. As an example, the analysis engine 204 may select the generated profile only if the analysis engine 204 determines that the generated profile satisfies both a clinical effectiveness requirement and a financial requirement. The assessment of multiple requirements may enhance the effectiveness of the matching algorithm by taking advantage of the multifaceted profile data produced as described above in reference to FIG. 3A.

Determining that the generated profile satisfies the at least one requirement may include determining whether the generated profile satisfies a clinical effectiveness requirement (306a). In one embodiment, determining whether the generated profile satisfies a clinical effectiveness requirement may include, for example and without limitation, determining whether the profiled professional or entity satisfies a requirement regarding a particular clinical experience or a requirement regarding a level of quality of care provided by the profiled professional. In another embodiment, the analysis engine 204 determines that the profiled professional or entity is associated with an area of specialty identified in the at least one requirement. For example, the analysis engine 204 may determine whether the profiled professional or entity is associated with an area of specialty identified in the at least one requirement. As another example, the requirement may specify, without limitation, a case history of the profiled professional, a number of referrals to the profiled professional by other industry professionals, or prior patient outcome (e.g., statistical data on patient outcomes for patients seen by the profiled professional, such as rate of readmission or patient compliance with medical treatment).

In some embodiments, the analysis engine 204 determines whether the generated profile satisfies a clinical effectiveness requirement by determining that the profiled professional has a sufficient workload in an area of specialty identified in the at least one requirement. For instance, research regarding medical fields indicates that a minimum threshold of clinical fluency is critical in providing appropriate patient care; thus, in one embodiment, the analysis engine 204 may determine that the profiled professional is more likely to meet the clinical effectiveness requirement if the profiled professional performs more than a certain threshold number of procedures similar to a procedure specified in the referral opportunity. Professionals in other fields also may require workload exceeding a certain threshold to achieve maximal effectiveness.

FIG. 3F illustrates steps for determining that the professional has sufficient workload in an area of specialty in some embodiments. In one embodiment, determining that the generated profile satisfies a clinical effectiveness requirement (306a) involves determining, by the analysis engine 204, for a type of procedure, a total number of procedures performed by a plurality of professionals, the plurality including the profiled professional (322); determining, by the analysis engine, a percentage of the total number of procedures performed by the profiled professional (324); and determining, by the analysis engine, that the determined percentage for the profiled professional exceeds a threshold (326).

Referring to FIG. 3F in more detail, and by reference to FIGS. 2-3E, the analysis engine 204 may determine, for a type of procedure, a total number of procedures performed by a plurality of professionals, the plurality including the profiled professional (322). The plurality of professionals may be some or all of the professionals that work for the entity for which the profiled professional works. For instance, the plurality of professionals may be the set of professionals that work in a particular department with the profiled professional. In one embodiment, the plurality of professionals is a plurality of physicians employed by an organization such as a hospital. In another embodiment, the plurality of professionals is a plurality of physicians that work in a particular medical field within the hospital, such as a cardiology department at the hospital. Although the methods and systems described herein provide functionality applicable to organizations with any number of physicians, such methods and systems may be particularly helpful in managing organizations with large numbers of physicians. For example, some hospitals (or networks of affiliated hospitals) may employ hundreds or even thousands of physicians and implementing functionality for optimizing patient allocation may be particularly beneficial to such organizations. The plurality of professionals may be some or all of the professionals that work in a geographic region in which the profiled professional works. The plurality of professionals may be some or all of the professionals belonging to a professional organization in which the profiled professional is a member.

In some embodiments, an entity employing the profiled professional provides the data analyzed by the analysis engine 204. For instance, where the profiled professional is a physician, the healthcare organization employing the professional may provide the data analyzed by the analysis engine 204. In one embodiment, the analysis engine 204 accesses a scheduling database to determine the total number of procedures performed by the plurality of professionals. In another embodiment, the analysis engine 204 accesses an electronic medical record database to determine the total number of procedures performed by the plurality of professionals. In still another embodiment, the analysis engine 204 accesses a billing database to determine the total number of procedures performed by the plurality of professionals. In yet another embodiment, the analysis engine 204 accesses a claims database (e.g., a database of claims made to insurance companies for reimbursement) to determine the total number of procedures performed by the plurality of professionals. The data collected for this analysis may be incorporated in a profile as described above in reference to FIG. 3A; the data may be regularly updated along with other data in the profile, for instance by repeatedly querying databases, remote devices, or institutions possessing the data. The data may also be updated in response to events detected by the analysis engine 204; for instance, if the profiled professional changes employers, the analysis engine 204 may, upon receiving data describing the change of employment, collect data concerning a new plurality of professionals representing the new colleagues of the profiled professional.

In some embodiments, the analysis engine 204 accesses at least one database of procedure-related data, the at least one database undergoing modification by one or more entities. For example, a hospital may authorize the analysis engine 204 to access “live” databases such as scheduling databases that are actively used to create and modify scheduling data related to the type of procedure. Providing the analysis engine 204 with access to databases that are in use and subject to ongoing modification may allow the analysis engine 204 to make more accurate determinations than if the analysis engine 204 were restricted to historical data. In some embodiments, the analysis engine 204 receives access to both databases of historical data and to databases subject to ongoing modification.

In one embodiment, the analysis engine 204 accesses a database 212 to determine the total number of procedures of a particular type performed by the plurality of professionals. In another embodiment, the analysis engine 204 determines the total number of procedures of the type performed during a retrospective time period (e.g., the previous day, month, quarter, year, and so on). For example, the analysis engine 204 may retrieve data from the database 212 to determine how many heart surgeries all of the physicians at a particular hospital performed during the previous year. In another embodiment, the analysis engine 204 determines the total number of procedures of the type for which the plurality of professionals have contemporaneous responsibility (e.g., on-going cases or cases assigned to the professionals as of the date of the analysis). In still another embodiment, the analysis engine 204 determines the total number of procedures of the type for which the plurality of professionals will, prospectively, have responsibility (e.g., a number of cases assigned to the professionals as of the date of the analysis plus a prediction as to how many cases the professionals will have in a future time period). A user of the system 200 may specify the time period, the type of procedure, or other data used by the analysis engine 204 during execution of the optimization method.

Determining that the profile satisfies a clinical effectiveness requirement 306a may include determining, by the analysis engine, a percentage of the total number of procedures performed by the profiled professional (324). In one embodiment, the analysis engine 204 determines the percentage of the total number of procedures performed by each professional. For example, the analysis engine 204 may determine that 200 heart surgeries were performed in the previous year and the analysis engine 204 may determine that Doctor Smith performed 25% of those 200 heart surgeries.

The analysis engine 204 may access data stored in the database 212 to make the determination. Data may include, without limitation, information associated with an organization (such as a hospital), information associated with a professional, diagnosis code(s), procedure code(s), cost of procedure, patient length of stay in the organization, a type of admittance to the organization (e.g., emergency or elective), and a financial class of a patient (e.g., self-pay or Medicare).

As shown in FIG. 3G, the analysis engine 204 may generate a table 330 or other data structure storing the determined total number and the determined physician percentages. In one embodiment, the analysis engine 204 makes the table 330 available to users of the system 200. By way of example, and as shown in FIG. 3G, the analysis engine 204 may determine that a plurality of physicians perform 200 heart surgeries a year and store that information in table 330. Continuing with this example, the analysis engine 204 may determine that one of the plurality of physicians (“Smith” in the embodiment depicted in FIG. 3G) performed 40% of the 200 total heart surgeries while determining that a second of the plurality of physicians (“Miller” in the embodiment depicted in FIG. 3G) performed 5% of the 200 total heart surgeries.

Referring again to FIG. 3F, determining that the profile satisfies a clinical effectiveness requirement 306a may include determining, by the analysis engine, that the determined percentage for the profiled professional exceeds a threshold (326). In some embodiments, a user specifies the threshold. In other embodiments, the analysis engine 204 specifies the threshold. In some embodiments, the threshold is a percentage of a number of procedures performed by a second professional. In one of these embodiments, by way of example, the threshold is 60% of the procedures performed by the most experienced professional in the plurality of professionals. For example, and referring again to FIG. 3G, Dr. Smith may be considered the most experienced physician for heart surgeries since she has performed a greater percentage of the 200 heart surgeries performed by the plurality of physicians than any of the other physicians. The threshold in such an example would therefore be 25% (e.g., 200*0.41 is 82 heart surgeries by Dr. Smith, 82*0.6=49 heart surgeries; 49/200=25%). In such an example, Dr. Jones would exceed the threshold since he has performed more than 25% of the total number of heart surgeries, but Drs. Williams and Miller would not meet the threshold.

As indicated above, in some embodiments, the threshold is specified as a relative value (for example, without limitation, a percentage of a number of another physician's procedures). In other embodiments, however, the threshold is a range of numbers. In still other embodiments, the threshold is a specific number. For example, either a user of the system 200 or an administrator of the analysis engine 204 may specify the number, or the analysis engine 204 may be configured to use a particular number during an initialization or configuration process.

In some embodiments, the threshold is a minimum clinical fluency threshold. In one of these embodiments, the threshold is determined based on scientific research focused on a particular type of procedure. In another of these embodiments, the threshold identifies a number of procedures below which it may be unsafe to have the professional perform the procedure. By way of example and without limitation, the user or the analysis engine 204 may access data (e.g., scientific research) to determine that when a physician performs less than 5% of the total number of procedures of a particular procedure type within a time period (e.g., a year), the quality of the physician's work suffers. Work quality may be determined by a user or by the analysis engine 204 and may be determined based on scientific research. For example, where the professional is a physician, work quality may be determined based on how long a physician takes to complete a procedure, how well the patient recovers from the procedure, or how much the procedure costs. As another example, the analysis engine 204 may analyze medical data associated with procedures previously performed (e.g., billing data and insurance data) and determine that when physicians perform less than 5% of a total number of heart surgeries, each surgery costs more, the physicians take more time to complete the surgery, or the patient has an increased risk of dying; in some embodiments, the determination is normalized for factors such as patient conditions (e.g., to account for the fact that some doctors may have lower success rates because they take on more complex cases). In one embodiment, and as depicted in FIG. 3G, the analysis engine 204 may store an indication of whether the determined percentage for the profiled professional exceeds the threshold. The analysis engine 204 may also rank professionals according to the degree to which they exceed the threshold, and may preferably select a professional having a higher ranking over one that exceeds the threshold to a lesser extent.

In some embodiments, analysis engine 204 may determine that the profiled professional is a good choice for the referral opportunity because a more experienced professional has too great a workload to perform adequately if given the referral. As another example, the analysis engine 204 may determine that, based on relative experience, although a first professional would be ideal, a second professional with less experience than the second has relatively more experience than another alternative. For example, referring to FIG. 3G, although the analysis engine 204 may identify Dr. Smith as having an optimal workload, if Dr. Smith cannot take on any additional procedures, patients, or other tasks, the analysis engine 204 may determine that a better referral candidate for the referral opportunity is Dr. Jones, who has also exceeded the threshold, although not by as much as Dr. Smith.

The system 200 may further execute a method to recalculate the workload analysis for clinical effectiveness. Therefore, in one embodiment, the methods described herein include determining, by the analysis engine, that data relating to the total number of procedures has changed, and automatically re-determining, by the analysis engine, whether the determined percentage for the profiled professional exceeds the threshold. In some embodiments, the analysis engine 204 periodically updates the threshold calculation for the profiled professional; the updating process may occur as part of the updating process for the profile. Due to the system 200 functionality for continuously re-evaluating types of procedures professional in a plurality of professionals, the system 200 may be said to operate in real-time.

In some embodiments, the analysis engine 204 analyzes third-party input to determine whether the generated profile satisfies the at least one requirement. For example, the analysis engine 204 may analyze data generated by the referring professional (e.g., particular personal experience of the referring professional with one or more profiled professional). In another example, the analysis engine 204 may analyze data generated by a peer of either the referring professional or the profiled professional. In a further example, the analysis engine 204 analyzes data associated with a subject of the referral opportunity; for instance, the analysis engine 204 may analyze data associated with a patient including diagnoses, past history, prior successful or unsuccessful treatments, and patient preferences.

Referring again to FIG. 3E, determining that the generated profile satisfies the at least one requirement may include determining whether the generated profile satisfies a financial requirement (306b). For example, the analysis engine 204 may determine whether a cost profile for a profiled professional or entity satisfies the at least one requirement by determining whether the profiled professional or entity satisfies a threshold level of cost effectiveness. As an example, the analysis engine 204 may determine a level of cost efficiency of the profiled professional or entity generally or for a specific procedure. In some embodiments, the analysis engine 204 may analyze data associated with the professional or entity although not explicitly in the profile, such as billing data, to make the determination. In other embodiments, the analysis engine 204 may analyze data associated with the professional or entity but not in the profile at all. In one of these embodiments, for example, the analysis engine 204 accesses an eligibility lookup system (such as, for example, a system which may be provided by an insurance company) to determine whether, and to what extent, an insurance company covers one or more patient-physician interactions and whether the level of coverage satisfies the at least one requirement of the referral opportunity.

Determining that the generated profile satisfies the at least one requirement may include determining whether the generated profile satisfies an operational requirement (306c). For example, the analysis engine 204 may determine whether the profiled professional has availability in his or her schedule to undertake the referral opportunity, which may include an identification of a timeframe within which the referral appointment should take place. The analysis engine 204 may determine whether the profiled entity has availability in its schedule, or in at least one schedule of an individual associated with the profiled entity, to undertake the referral opportunity. The analysis engine 204 may determine whether the profiled entity has space available to undertake the referral opportunity. The analysis engine 204 may determine whether the profiled entity has staff available to undertake the referral opportunity. The analysis engine 204 may determine whether the geographic region or other location-based characteristic of the profiled professional or entity satisfies the at least one requirement.

Determining that the generated profile satisfies the at least one requirement may include determining whether the generated profile satisfies a verification requirement (306d). In some embodiments, the first computing device 106a provides functionality both for identifying a profiled professional who satisfies the requirements of the referral opportunity and for connecting the profiled professional with a subject of the referral opportunity. In one of these examples, after the analysis engine 204 determines that the profiled professional satisfies the requirements of the referral opportunity, the first computing device 106a completes a verification process as part of the process of connecting the profiled professional with a subject of the referral opportunity. For example, the workflow engine 206 may maintain a state for each part of the verification process and generate a notification at the completion of each required stage. By way of example, in an embodiment in which the referral opportunity specified a requirement relating to insurance, the workflow engine 206 may maintain a state for a request, by the analysis engine 204, from an insurance company or a remote machine 106b associated with the insurance company, for confirmation of eligibility of a patient to see a profiled physician.

As an additional example of determining whether the generated profile satisfies a verification requirement, the workflow engine 206 may verify association with a network (including, e.g., hospital networks, accountable care networks, or other organizational structure of a hospital system). As another example of determining whether the generated profile satisfies a verification requirement, the workflow engine 206 may verify patient eligibility verification, including, for example, insurance verification, and other patient-oriented verification metrics. As an additional example of determining whether the generated profile satisfies a verification requirement, the workflow engine 206 may verify one or more credentials, including, for example, such factors as whether the profiled professional has an active license and no disciplinary actions.

In some embodiments, the first computing device 106a provides feedback to one or more other computing devices throughout the process of analyzing profiles and selecting profiled professionals who qualify for one or more referral opportunities. For example, the first computing device 106a may provide feedback to a second computing device 102 identifying characteristics of a referral opportunity that impacted the selection of a profiled professional or entity. As another example, the first computing device 106a may provide feedback to a profiled professional or entity identifying attributes of the profile that impacted the qualification of the profiled professional or entity for a referral opportunity. As another example, the workflow engine 206 may provide feedback to various computing devices identifying points in a verification process at which particular profiles were approved or filtered out (e.g., indicating to a referring physician that no insurance company would cover a particular type of referral or indicating to a profiled professional that he or she did or did not qualify for a referral opportunity based on insurance plans accepted, hours available, geography served, or other characteristic).

In some embodiments, therefore, the analysis engine 204 generates a referral based upon one or more types of analyses of one or more profiled professionals or entities. In one of these embodiments, for example, the analysis engine 204 analyzes at least one characteristic of a professional's profile to determine whether the professional is best suited for a particular patient, or to identify an alternative professional that would be better suited for the particular patient. For example, the analysis engine 204 may identify for a first doctor a plurality of professionals whose profiles indicate they would be well suited for a particular referral and then predict which of the plurality of professionals would be best suited for the referral via, for example, rank-ordering of the plurality of professionals. In such an embodiment, the system may provide personalized predictive modeling of patient outcomes, using physician characteristics as inputs.

In some embodiments, the analysis engine 204 leverages both static and dynamic attributes in the profile when generating a referral. In other embodiments, the analysis engine 204 uses ranking to satisfy a plurality of requirements, which, as indicated above, may include requirements regarding availability, competency, financing, and operational constraints. In one of these embodiments, the analysis engine 204 is able to satisfy two or more constraints providing an improved experience. By way of example, and without limitation, a first professional may match all constraints but the analysis engine 204 may also identify a second professional that matches a subset of the constraints and that the analysis engine 204 determines to include in an enumeration of potential referrals. In another of these embodiments, a user can control the requirements evaluated by the analysis engine 204. For example, and without limitation, any user of the system, including profiled professionals, professionals requesting recommendations for referrals, and patients or patient representatives of any type, may access a user interface to specify the one or more requirements. Such interfaces may also allow users to sort referral recommendations by the at least one requirement (e.g., specifying a requirement by which the list should be sorted). In still another of these embodiments, the analysis engine 204 uses dynamic information to do the ranking (e.g., dynamically updated as described above). In another of these embodiments, the system 200 provides functionality for requesting referral recommendations in real-time (e.g., referral recommendations based upon data retrieved and updated at substantially the same time as the request is received).

In some embodiments, the at least one requirement is a plurality of requirements, and the analysis engine 204 assesses each profile according to the plurality of requirements. In one of these embodiments, given a profile that has a plurality of attributes at least some of which are dynamically updated at a high frequency, the system 200 provides functionality for matching one or more of the plurality of constraints requested with one or more profiles that match at least a subset of the constraints. For example, a patient may indicate she wishes to work with a professional who is a female and is available for an annual visit in the next week and can meet at a location within 5 miles of the patient's home; the patient may further indicate that if such a professional is available, the patient would like to schedule a visit to see this professional. There may be other providers that partially satisfy the specified constraints. In some embodiments, the analysis engine 204 scores a match between the plurality of requirements and each profile and then ranks the identified profiles based on a rank ordering of the scores. The analysis engine 204 may create a referral for the highest-ranking profile. Continuing with the example above, the analysis engine 204 may determine that at least one provider is female and is available for an annual visit within the requested time period (seven days from the date of the request) but the at least one provider is not available to meet within a five mile radius of the patient's home; in such an instance, the analysis engine 204 may rank those providers that match a maximal set of constraints ahead of providers who match partial constraints.

In another example, the analysis engine 204 may determine that there are no providers who satisfy all of the constraints but several providers who each may satisfy a partial set of constraints; in this example, the analysis engine 204 provides high quality scoring of results and consequent ranking in order to identify non-matching providers that still provide utility for the requesting user. Continuing with this example, the analysis engine 204 may determine that one set of providers includes: a first provider who is female, has availability in two weeks for an annual visit, and is located within 15 miles of patient's home; a second provider who is male, has availability in one week for an annual visit, and is located within 5 miles of patient's home; and a third provider who is female, has availability in three weeks for an annual visit, and is located within 15 miles of patient's home. As each of the providers represents a partial match to the requirements in the example, the analysis engine 204 may rank the providers according to the number of matched criteria; for instance, the second profile may receive a higher ranking because it matches two of the requirements while the other two profiles match only one requirement each.

The weight assigned to each requirement may be automatically inferred based on the behavior of users who have used the system. For example, the system may show users alternate orderings of the different sets of providers described above and based on the selections users have made in the past, may infer that a particular ordering may be preferred by users. The analysis engine 204 may use standard statistical techniques such as correlation as well as modern methods such as machine learning to generate such inferences.

In some embodiments, the analysis engine 204 ranks partially matching profiles by assigning varying weights to each of the plurality of requirements. For instance, in the above example, the analysis engine 204 may confer a higher weight on the requirement that the provider is female, and a lesser weight on distance requirements, so that a female provider available this week who is 7 miles from the patient's house is ranked higher than a male provider available this week who is 5 miles from the patient's house; such weights may be assigned based on user-specified preferences, pre-defined rules, needs of a health system, or other basis for prioritization of requirements.

The weight assigned to each requirement may be defined specifically based on the needs of a particular health system. For example, a health system may define additional attributes that may be used for ranking the returned provider list. As a non-limiting example, given the relatively skilled resource that a physician represents, health systems increasingly are trying to have nurse practitioners see many types of cases for which they are clinically appropriate. Attaining the credential of a nurse practitioner does not require as much education as attaining the credential of a medical doctor. Thus, nurse practitioners tend to be less expensive resources in the health system at large for providing health care. Consequently, a health system may impose a requirement that a case of the common cold be seen by a nurse practitioner, and require that an internal medicine doctor see a case of mild chest pain. The health system may encode such a business rule using the features provided by the system 200 so that when the analysis machine 204 generates an enumeration of profiles that match the requirements specified in requests for referrals, the analysis machine 204 is able to include such additional business rules when computing scores and ranking the order of the profiles. In some embodiments, the additional requirements are included in the entity profile of the institution corresponding to the health system; the additional requirements may also be included in the profile of each professional associated with the institution.

Certain requirements may be associated with an indication as to whether they are optional or can be relaxed (such requirements may be said to have the property that they cannot be relaxed). In some embodiments, and as a result of a requirement having such a property, the analysis machine 204 may omit all profiles that do not match the requirements. For example, chemotherapy treatment for a cancer patient is time-sensitive, and therefore if no healthcare provider can be found to match that constraint, the user may be notified that no provider matches a required constraint. The user may be moved into an alternate workflow as a result; for example, the user may be asked to contact a specific phone number to get additional assistance.

Other requirements may be assigned a degree of importance or of latitude in applying the requirement—that is, instead of being requirements, it may be optional to apply the constraint. In one embodiment, a requirement represents the preferences of a user, such as the preference for a female doctor. In another embodiment, an optional requirement represents a preference of the health system, such as a preference for nurse practitioners over physicians when both sets of providers are clinically qualified to see the same condition. An optional requirement may reflect a preference of a physician. For example, a neurosurgeon may prefer not to see headaches and the health system may prefer that the neurosurgeon only see complex neurosurgery cases even though a neurosurgeon is clinically qualified to see a patient with a headache.

When attempting to identify profiles that satisfy the constraints specified in the request, the analysis engine 204 may use all available profile information. Such information would include information that is updated in real-time. For example, the available appointment slots for a physician will change as soon as an appointment is booked and the analysis engine 204 may include functionality to use the updated availability data in subsequent searches in order to provide an accurate enumeration of profiles that fulfill (partially or completely) constraints specified in the request.

Where the requirements pertain to profile attributes that are subject to rapid change through an updating process as described above in reference to FIG. 3A, the analysis engine 204 may update the ranking to reflect modifications to the attributes. Returning to the above example, the female provider within 5 miles of the patient's home and available for a visit next week may have a change of schedule, which is automatically updated to her profile, indicating that she is no longer available for an appointment next week; the ranking may be modified to give a higher ranking to a second provider who is female, available next week, and located 7 miles away.

Other examples of dynamically updated information include clinical skills associated with the population of healthcare providers. While the clinical skills associated with a single provider may not change frequently, the clinical skills associated with a population of providers may change multiple times per day as new clinicians are added, existing clinicians leave, and some clinicians change their skill sets. Such information may be updated as soon as it becomes available so that subsequent searches accurately identify an enumeration of profiled professionals that satisfy (partially or completely) the requirements of the subsequent searches; the analysis engine 204 may use the updated information to recalculate the degree to which a profile matches the requirements and to modify the corresponding ranking. Dynamic constraints are important inputs into the scoring computation that is used when providers partially match the constraints specified in the request. By incorporating dynamic information into such scoring computations, the analysis engine 204 improves the utility of the ordered results, avoiding returning suboptimal rank orders relative to the original request.

In some embodiments, the use of dynamically updated data collected in a manner that balances performance constraints, the speed at which different categories of data change, and the relative importance of different categories of data enables the analysis machine 204 to generate recommendations for referrals based on current, accurate information. In other embodiments, the use of near-instant electronic communication between the analysis machine 204, profile generator 202, and administrative or clinical machines at distributed locations allows the system 200 to greatly exceed the scheduling capabilities of traditional scheduling platforms, particularly in fields such as medicine where accurate management of complex factual situations is particularly crucial.

Referring back to FIG. 3A, the method includes transmitting, by the analysis engine, to the second computing device, the identification of the at least one of the professional and the entity (308). In one embodiment, the analysis engine 204 transmits the identification of the referral opportunity to the second computing device 102. In another embodiment, the analysis engine 204 transmits the identification of the referral opportunity to the profiled professional.

In some embodiments, the methods and systems described herein provide functionality allowing the referring physician to contact the profiled professional regarding the referral opportunity. In some embodiments, the methods and systems described herein provide functionality allowing the referring physician to contact an individual associated with the profiled entity regarding the referral opportunity. In other embodiments, the methods and systems described herein provide functionality for scheduling an appointment between the subject of the referral opportunity and the profiled professional. In further embodiments, the methods and systems described herein provide functionality for transacting a referral such that the referring professional maintains coordination of care and shares appropriate data with the appropriate parties to effect the transaction. In one of these embodiments, the methods and systems described herein further provide functionality allowing the referring professional to connect with the subject of the referral during and after the completion of the referred work and to follow up with the subject of the referral regarding a level of quality of the subject's experience.

In some embodiments, the analysis engine 204 generates the identification of profiled professionals that satisfy the at least one requirement in near real time, that is, at substantially the same time as the request for the identification is received. In one of these embodiments, this functionality provides increased usability in implementations in which users will interact with the system to review the results contained in the responses, then reformulate or modify their query if none of the results are satisfactory, and then resubmit their query. In another of these embodiments, by providing functionality with which the analysis engine 204 may evaluate multiple combinations of criteria substantially simultaneously, the system provides improved usability.

In some embodiments, the user reviews the identification of the at least one of the professional and the entity, and decides that none of the results are satisfactory. The user may then enter a new instruction modifying the at least one requirement. In some embodiments, the analysis machine 204 determines that at least one second profile satisfies the at least one requirement as modified; the analysis machine 204 may perform this determination as disclosed above in reference to FIG. 3A. The analysis machine 204 may be able to perform the re-determination in substantially real time, ensuring that the determination is performed using current information. In some embodiments, in addition to computing the set of valid providers based upon the updated criteria, the analysis machine 204 also displays partial matches as described above in reference to FIG. 3A.

In some embodiments, the analysis machine 204 computes and returns the valid attribute values for each requirement that could be used to further subset the results, without ending the search with a null result set; as a result, if the user has added such an attribute value to their query criteria, the resulting set of matching providers may return results that do not match that value, and indicate that no results matched the value. By way of example, the user could add the attribute value to a new search (e.g., a search within the search results) in order to further narrow the results. In some embodiments, allowing users to interactively modify the requirements allows users to choose the criteria that matter to them interactively so that they can find a provider who best matches their needs. Each user selection of a new requirement may cause the analysis machine 204 to organize new results in subsets, allowing the user to see the effect of the new requirement. The user may also be able to remove requirements; the analysis machine 204 may then find one or more profiles matching the at least one requirement absent the removed requirements, as disclosed above in reference to FIG. 3A.

In another embodiment, the analysis engine 204 is able to filter out criteria that would lead to zero results, improving user experience since the set of all possible combinations of filter values is significantly larger (e.g., by many orders of magnitude) than the set of valid (e.g., non-zero) combinations of filter values, where a valid combination of filter values is one that can be satisfied by at least one profiled professional.

In some embodiments, the system 200 leverages existing user interface technology such as, without limitation, guided navigation, guided search, or faceted search interfaces.

The user may also be able to enter one or more criteria to sort the result set. In addition to returning results from the analysis engine 204 in the order determined by a scoring computation (e.g., rank-ordering algorithm), in some embodiments, the system 200 allows users to retrieve results ordered by one or more criteria (e.g., sorted by last name, sorted by distance, sorted by availability, etc.). The user may enter instructions creating a nested sort, for example by having the results ordered first by the nearest week in which the professionals are available, and second by the distance from the patient's house. The analysis machine 204 may order the results according to rankings created as described above in reference to FIG. 3A, by default. In some embodiments, the analysis machine 204 indicates result rankings so determined even when the results are ordered according to a user-entered sorting criterion; for instance, the analysis machine may display a cardinal number next to each result corresponding to the result's determined ranking.

In addition to referring professionals, users may be the recipients of the referrals themselves, and may make selections to reflect their preferences by interacting directly with an electronic system such as a website, a custom application, or a mobile application. In other embodiments, the user is a third party mediating an interaction for a patient, such as checkout clerk at a clinic, a referral coordinator in an urgent care center, or a call center operator in the central scheduling center for a major hospital.

In some embodiments, the first computing device 106a integrates with one or more remote machines to provide the functionality described herein. For example, in one embodiment, the first computing device 106a is in communication with a remote machine 106b that provides access to electronic medical records from which the first computing device 106a can identify data associated with the profiled professional or entity (e.g., outcomes of patients previously treated by a physician) and data associated with the subject of the referral opportunity (e.g., a case history, diagnoses, previous effective treatments, or other patient data). As another example, the first computing device 106a may be in communication with customized databases (e.g., databases containing patient or physician data). As a further example, the first computing device 106a may be in communication with scheduling systems, eligibility lookup systems, and clinical environments generally.

In some embodiments, the first computing device 106a is in communication with a bidding system (not shown). For example, the first computing device 106a may incorporate or be in communication with a financial market bidding system in which healthcare providers bid for referral opportunities based on at least one of price and quality (e.g., allowing a referring physician to identify the best doctor available for the lowest fees). An entity such as an accountable care organization may make a determination as to what tests or procedures they are willing to offer at particular price points in order to qualify for particular referral opportunities.

The method includes receiving, by the first computing device, an indication as to whether a user of the second computing device made a referral to the at least one of the professional or the entity (310). In some embodiments, the first computing device 106a receives the indication from the referring professional via the second computing device 102. The first computing device 106a may provide a user interface 210, such as a web page, by means of which the referring professional may indicate that he or she has made the referral choice. In some embodiments, the first computing device 106a receives an indication that the referring professional has made the referral from a remote device 106b; for example, and without limitation, a remote device 106b associated with the referred professional may transmit the indication to the first computing device 106a.

The method includes updating, by the profile generator, the profile of the at least one of the professional and the entity responsive to the received indication (312). In some embodiments, the profile generator 202 updates a level of expertise of the at least one of the professional and the entity in an industry. For instance, the profile generator 202 may increase the level of expertise of the professional in general each time the first computing device 106a receives a referral from a referring physician. The profile generator 202 may increase the level of expertise of the professional in a particular field each time the first computing device 106a receives a referral from a referring physician. In some embodiments, the profile generator 202 updates the level of expertise by receiving data describing the outcome of the referral, and updating the level of expertise to reflect that data. For example, and without limitation, the profile generator 202 may receive data indicating the clinical outcome of the referral. The profile generator 202 may receive patient feedback concerning the referral. The profile generator 202 may receive feedback concerning the referral from the employer of the professional. In some embodiments, the profile generator 202 receives feedback from the referring professional. The profile generator 202 may receive information concerning the outcome of the referral from the professional to whom the referral was given.

In some embodiments, the profile generator 202 modifies a category of expertise of the at least one of a professional and an entity. The profile generator 202 may determine that the referral concerns a particular category of expertise. The referral may explicitly indicate the category of expertise to which it pertains. The analysis engine 204 may determine that the referral implicitly describes a category of expertise that concerns the referral. In some embodiments, the analysis engine 204 associates a procedure requested in the referral with a category of expertise. In some embodiments, the analysis engine 204 associates a diagnosis requested in the referral with a category of expertise. In some embodiments, the profile generator 202 adds a new category of expertise to the profile of the professional. In some embodiments, the profile generator 202 adds a new category of expertise to the profile of the entity. In some embodiments, the profile generator 202 increases the level of expertise of the professional in a category of expertise associated with the referral.

In one embodiment, therefore, the methods and systems described herein provide functionality for data-driven management of referrals between physicians, in a manner that records the occurrence of such referrals, and uses that occurrence as additional data to aid in future referral management. In contrast to existing systems where a physician seeking to make a referral is typically limited to individuals of which the physician is aware (e.g., other physicians known to the referring physician), and which are conventionally based on subjective knowledge of the referring physician, implementation of the methods and systems herein provide functionality for objectively identifying relevant physicians, regardless of a personal connection between the two physicians, while assuring the referring physician that the person to whom he or she is sending a patient satisfies any needs, desires, or requirements the patient has. By way of example, a referring physician may have a patient requesting access to a physician practicing in a specified geographic location but the referring physician may not know any practicing physicians in the specified geographic location who also satisfy a requirement of the referring physician (such as, a particular medical specialty, or level of expertise, or accepting new patients within a particular time frame); however, rather than having to refer the patient to someone unknown to the referring physician or to someone that fails to satisfy the patient's requests, the referring physician may utilize the methods and systems described herein to identify an appropriate physician to which to refer the patient. Furthermore, the record of past referrals offers the referring physician both a record of his or her own past choices and an additional metric to gauge the confidence that other professionals place in the professional in question.

Although some of the examples provided herein describe the analysis in connection with the medical profession, the legal profession, and other professional service industries, one of ordinary skill in the art will understand that the methods and systems described herein are equally applicable in other industries. Similarly, although the description above categorizes professionals as industry professionals (such as providers of goods or services), professionals such as physicians, and employers of professionals, it should be understood that any one individual may be categorized as any one or more of these types of professionals; for example, an industry professional need not be a vendor but could be a physician seeking to provide an opportunity to another physician and an employer in a particular instance may be better categorized as an industry professional.

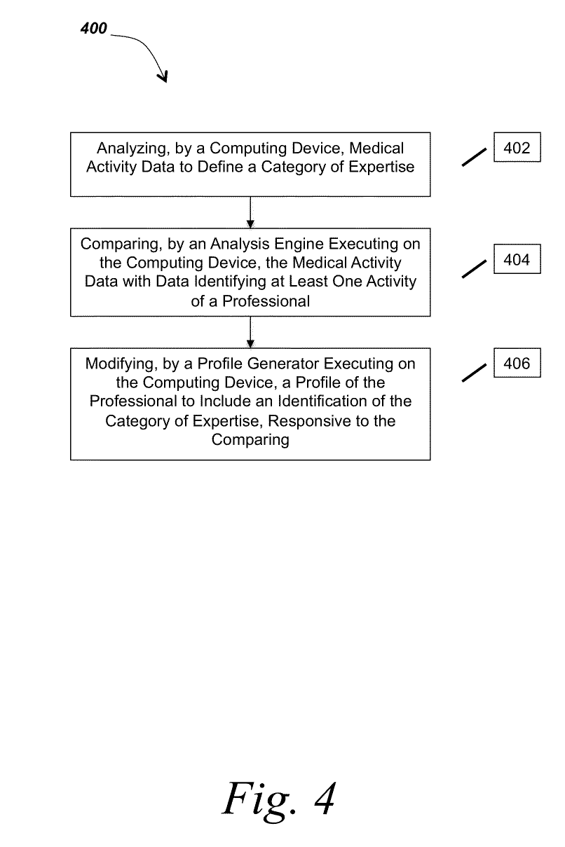

Referring now to FIG. 4, a flow diagram depicts one embodiment of a method 400 for associating a professional with a category of expertise. In brief overview, the method 400 includes analyzing, by a computing device, medical activity data to define a category of expertise (402). The method 400 includes comparing, by an analysis engine executing on the computing device, the medical activity data with data identifying at least one activity of a professional (404). The method 400 includes modifying, by a profile generator executing on the computing device, a profile of the professional to include an identification of the category of expertise, responsive to the comparing (406).

Referring now to FIG. 4 in greater detail, and in connection with FIG. 2, the method 400 includes analyzing, by a computing device, medical activity data to define a category of expertise (402). In some embodiments, an analysis engine 204 imports a list of categories, such a published list of medical specialties. In some embodiments, the analysis engine 204 defines categories according to medical procedures. In some embodiments, the analysis engine 204 defines categories according to code-based classifications, such as the International Classification of Diseases (ICD), which provides codes for diseases and medical procedures arranged in a tree structure. In other embodiments, the analysis engine 204 creates its own categories by analyzing data concerning medical procedures. The data may come from billing records. The data may come from payroll records. The data may come from electronic medical records. The analysis engine 204 may identify statistically significant correlations of procedures in data describing the activities of medical professionals. For example, if a doctor who performs angioplasties is statistically highly likely to perform coronary thrombectomies, the analysis engine 204 could create a category of medical specialty reflecting that correlation. The analysis engine 204 may identify statistically significant correlations of procedures with educational specialties; for example, if a doctor whose residency was in interventional cardiology is highly likely to perform an angioplasty, the analysis engine 204 may associate the performance of angioplasties with the specialty of interventional cardiology.

In some embodiments, the analysis engine 204 combines imported lists of categories with the results of its data analysis to generate new categories. For example, and without limitation, the analysis engine 204 may create a tree data structure using ICD codes, and associate specialties with nodes in the tree. The analysis engine 204 may create additional nodes by adding classifications from other lists. The analysis engine 204 may create additional nodes by adding the results of its analysis of data concerning medical procedures, such as the statistical correlation of particular procedures with each other.

The method 400 includes comparing, by an analysis engine executing on the computing device, the medical activity data with data identifying at least one activity of a professional (404). In some embodiments, the analysis engine 204 determines that the professional has completed an educational requirement, such as a course of study in a particular medical specialty. In some embodiments, the analysis engine 204 determines that the professional has performed a medical procedure. The analysis engine 204 may determine that the professional has performed a medical procedure by determining that the professional has billed for the medical procedure. The analysis engine 204 may determine that the professional has performed a medical procedure by referring to electronic medical records. The analysis engine 204 may determine that the professional has performed a medical procedure by referring to payroll records. In some embodiments, the analysis engine 204 determines whether the professional has frequently performed a particular medical procedure. In some embodiments, the analysis engine 204 maintains a threshold number representing a minimum number of occurrences of the medical procedure to qualify for the category of expertise, enumerates the separate occurrences of the medical procedure indicated in the data identifying the at least one activity of the professional, and compares that enumeration to the threshold number. In some embodiments, the analysis engine 204 compares a set of medical procedures performed by the professional to a set of medical procedures associated with a category of expertise the analysis engine 204 has defined.

The method 400 includes modifying, by a profile generator executing on the computing device, a profile of the professional to include an identification of the category of expertise, responsive to the comparing (406). In some embodiments, the profile generator 202 adds the category of expertise to a set of categories of expertise in the professional's profile. In some embodiments, the profile generator 202 modifies a category of expertise already in the professional's profile to reflect the category. For instance, the profile generator 202 may modify the profile of an interventional cardiologist, which contains a category of expertise describing interventional cardiologists in general, by changing that category of expertise to that of an interventional cardiologist who specializes in angioplasties, because of data showing frequent performance of angioplasties. In some embodiments, the profile generator 202 replaces a former category of expertise with a different one that more accurately reflects the current data. As an example, analysis of new medical activity data may have led the analysis engine 204 to create a new category that more closely matches the activity of the professional than the former category did. Alternatively, the professional may have performed a particular activity frequently in the past, but since have ceased to perform it; the profile generator 202 may remove from the professional's profile a category that depended on the frequent performance of that procedure.

In some embodiments, the analysis engine 204 determines that the at least one activity does not correspond to any extant category of expertise, and defines a novel category of expertise corresponding to the at least one activity. The analysis engine 204 may determine that the activity is one that is not listed in the medical activity data that the analysis engine 204 used to define categories of expertise; for instance, the professional may have invented a new procedure, such as a previously impracticable organ transplant, or a novel treatment course for a formerly incurable cancer. The analysis engine 204 may determine that a set of activities performed by the professional does not correspond to any correlated sets of activities in the currently defined categories of medical expertise. The analysis engine 204 may maintain a threshold number of occurrences for a particular novel activity pattern, and only create a new category if the number of occurrences exceeds the threshold. For example, if a doctor successfully treats a single case of congenital ichthyosis with hypnosis, but does not succeed in treating further cases, the analysis engine 204 may not create a new category corresponding to the treatment of congenital ichthyosis through hypnosis, but if the professional treats ten patients successfully, the analysis engine 204 may create the new category. In some embodiments, the profile generator 202 modifies the profile of the professional to include an identification of the novel category of expertise.

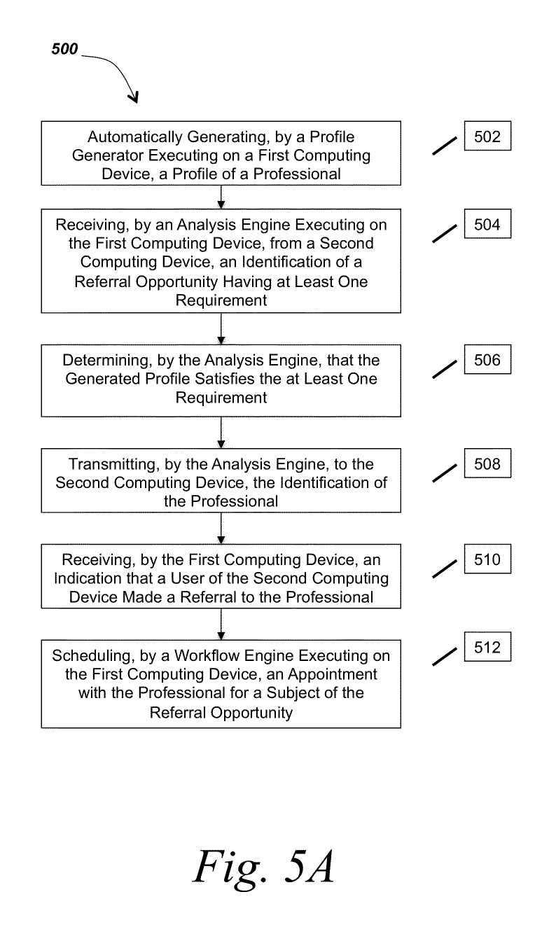

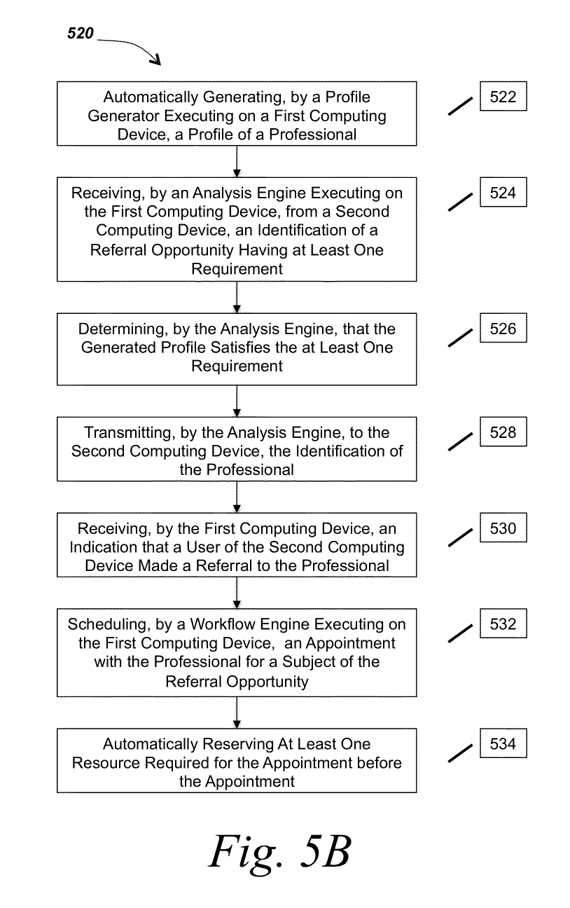

Referring now to FIG. 5A, a flow diagram depicts one embodiment of a method 500 for matching a professional with a referral opportunity and scheduling an appointment with the professional for a subject of the referral opportunity. In brief overview, the method 500 includes automatically generating, by a profile generator executing on a first computing device, a profile of a professional (502). The method 500 includes receiving, by an analysis engine executing on the first computing device, from a second computing device, an identification of a referral opportunity having at least one requirement (504). The method 500 includes determining, by the analysis engine, that the generated profile satisfies the at least one requirement (506). The method 500 includes transmitting, by the analysis engine, to the second computing device, the identification of the professional (508). The method 500 includes receiving, by the first computing device, an indication that a user of the second computing device made a referral to the professional (510). The method 500 includes scheduling, by a workflow engine executing on the first computing device, an appointment with the professional for a subject of the referral opportunity (512).

Referring now to FIG. 5A in greater detail, and in connection with FIG. 2, the profile generator executing on the first computing device automatically generates a profile of a professional (502). In some embodiments, the profile generator automatically generates a profile as described above in reference to FIG. 3A.

An analysis engine executing on the first computing device receives, from a second computing device, an identification of a referral opportunity having at least one requirement (504). In some embodiments, the analysis engine 204 receives the identification of the referral as described above in reference to FIG. 3A.

The analysis engine determines that the generated profile satisfies the at least one requirement (506). In some embodiments, the analysis engine 204 determines that the generated profile satisfies the at least one requirement as described above in reference to FIG. 3A.

The analysis engine transmits, to the second computing device, the identification of the professional (508). In some embodiments, the analysis engine 204 transmits to the second computing device 102 the identification of the professional as set forth above in reference to FIG. 3A.

The first computing device receives an indication that a user of the second computing device made a referral to the professional (510). In some embodiments, the first computing device 106a receives the indication as set forth above in reference to FIG. 3A.

A workflow engine executing on the first computing device schedules an appointment with the professional for a subject of the referral opportunity (512). In some embodiments, the workflow engine 206 transmits a message to the professional requesting that the professional provide availability data, receives a message from the professional describing availability data, and schedules the appointment using that availability data. The request may include a range of dates and times within which availability data is sought; for instance, if the appointment must be completed within two months of the referral, the request may ask the professional to indicate availability within that two-month window. Availability data may include dates and times during which the professional is available to engage in the appointment to be scheduled. The workflow engine 206 may use any means for communication via a network to send and receive the messages. For example, the workflow engine 206 may send the professional an electronic mail (email) message requesting the dates and times the professional has available. The professional may send the workflow engine 206 an email in response listing dates and times. In some embodiments, the presentation engine 208 provides to the professional a user interface by means of which the professional can enter availability data. For example, and without limitation, the presentation engine 208 may provide an interactive calendar into which the professional may enter dates and times of availability. In some embodiments, the workflow engine 206 receives availability data from a remote device 106b. As an example, the workflow engine 206 may receive availability data from a remote device 106b that maintains schedule information at the professional's place of employment.

In some embodiments, the availability data includes information describing the degree of urgency of already-scheduled appointments. In some embodiments, the availability data contains a description of the activity to take place in each scheduled appointment. In some embodiments, the availability data contains a standardized description of the activity to take place, such as an ICD code corresponding to the activity. In some embodiments, the availability data contains a description of the condition of a patient to be treated during an already-scheduled appointment. The availability data may describe the age of the patient. The availability data may describe the medical history of the patient. The availability data may describe the risk factors attendant to the treatment of the patient. The availability data may describe a current medical condition of the patient. In some embodiments, the availability data describes a condition of the patient using a standardized system, such as the ICD. In some embodiments, the availability data contains a ranking of the urgency of the already-scheduled appointment, with a higher ranking for an appointment that is more immediately necessary, and a lower ranking for an appointment that can be postponed more safely.

In some embodiments, the workflow engine 206 compares the urgency of an already scheduled appointment with the urgency of the appointment to be scheduled. The workflow engine 206 may generate a ranking for the urgency of the appointment to be scheduled, and compare that ranking to the ranking of the urgency of the already scheduled appointment. The workflow engine 206 may compare the state of health of the subject of the referral to the state of health of the patient in the already-scheduled appointment. For example, an appointment for an elderly person may be treated as more urgent than an appointment for a younger person, other factors being equal. In some embodiments, the condition to be treated in the appointment to be scheduled is described in a standardized form such as the ICD. In some embodiments, the workflow engine 206 compares the urgency of the treatment to be administered in the appointment to be scheduled with the urgency of the treatment to be administered in the already-scheduled appointment. In some embodiments, the treatment to be administered in the appointment to be scheduled is described using a standardized system, such as the ICD. In some embodiments, the workflow engine 206 follows a ranking protocol for the treatment of patients; for example, the workflow engine may follow a hospital's “triage” protocol for deciding which patient to treat first. In some embodiments, the workflow engine 206 calculates the relative ranking of the two appointments by following a set of protocols; for example, weighting the urgency of each appointment according to the urgency of each individual factor described above. In some embodiments, the workflow engine 206 consults a table or similar data structure listing the ranking of various appointments according to several factors.

In some embodiments, the workflow engine 206 reschedules an already-scheduled appointment if a comparison to the appointment to be scheduled reveals the latter to be more urgent. For instance, if the patient in the already-scheduled appointment is scheduled for an elective surgery whose outcome is unlikely to be affected by a delay, and the subject of the referral is being scheduled for an appendectomy, the elective surgery may be rescheduled to make room for the appendectomy. In some embodiments, the workflow engine 206 avoids rescheduling already-scheduled appointments if alternative times for the appointment to be scheduled are available. In some embodiments, the workflow engine 206 only reschedules an already-scheduled appointment if the rescheduling is medically necessary. In some embodiments, a user of the system may override the decision of the workflow engine 206 to reschedule; for instance, the professional to whom the referral is made may reject the rescheduling decision as contrary to his or her medical judgment, and enter an instruction overriding the rescheduling.

In some embodiments, the workflow engine 206 selects an appointment time from the availability data. The workflow engine 206 may select the appointment time by comparing the availability data to data indicating the availability of the subject of the referral. In some embodiments, the workflow engine 206 selects the earliest available date and time for the appointment time. In some embodiments, the first computing device 106a receives at least one preferred date and time from the subject of the referral, and the workflow engine 206 selects an appointment time corresponding to the at least one preferred date and time.

In some embodiments, the workflow engine 206 determines an amount of time required by the professional for the appointment. The workflow engine may determine the amount of time required by accessing the professional's profile; as an example, the workflow engine 206 may determine from the profile that the professional typically performs the type of appointment in question within 45 minutes. The workflow engine 206 may receive from the professional data indicating the amount of time required. The amount of time required may be included in the availability data. The workflow engine 206 may determine the amount of time required by calculating the typical amount of time professionals take to perform the type of appointment in question; for instance, the workflow engine 206 may access data describing the length of appointments of the type under consideration, and compute the median time required to complete the appointments recorded in that data. The workflow engine 206 may select an appointment time only if the availability data indicates that the availability data permits an appointment of at least the time required by the professional for the appointment, at that time.

In some embodiments, the workflow engine 206 determines that at least one resource required for the appointment is available. A resource may be a room in which the appointment would take place. For example, if the appointment is a surgical procedure, the workflow engine 206 may only select an appointment time during which an operating room is available. A resource may be a piece of equipment necessary for the appointment. For instance, the workflow engine 206 may only schedule an endoscopic procedure for a time when the required type of endoscopic device is available. A resource may be another professional necessary for the appointment; the workflow engine 206 may schedule a surgical procedure for a given time only if an anesthesiologist is available at that time. In some embodiments, the appointment requires a particular combination of resources, and the workflow engine 206 selects an appointment time in which the entire combination is available. A non-limiting example is a neurosurgical procedure that requires an operating room with an installed robotic surgical system, a complementary set of imaging technologies, a team of radiologists, technicians with specialized training, several nurses, and an anesthesiologist all to work together throughout the procedure.

The workflow engine 206 may obtain availability data for resources in any manner disclosed above. The workflow engine 206 may receive availability data from the professional, for instance via the user interface described above. The workflow engine 206 may receive the availability data from a remote machine 106b, such as a machine that stores scheduling information for the institution at which the professional works. If the resource is not available, the workflow engine 206 may request the identification of another professional from the analysis engine 204. In some embodiments, the analysis engine 204 queries the workflow engine 206 regarding availability of one or more resources as part of determining that the generated profile of a professional satisfies at least one requirement.

Referring now to FIG. 5B, a flow diagram depicts one embodiment of a method 520 for matching a professional with a referral opportunity, scheduling an appointment with the professional for a subject of the referral opportunity, and automatically reserving a resource required for the appointment. In brief overview, the method 520 includes automatically generating, by a profile generator executing on a first computing device, a profile of a professional (522). The method 520 includes receiving, by an analysis engine executing on the first computing device, from a second computing device, an identification of a referral opportunity having at least one requirement (524). The method 520 includes determining, by the analysis engine, that the generated profile satisfies the at least one requirement (526). The method 520 includes transmitting, by the analysis engine, to the second computing device, the identification of the professional (528). The method 520 includes receiving, by the first computing device, an indication that a user of the second computing device made a referral to the professional (530). The method 520 includes scheduling, by a workflow engine executing on the first computing device, an appointment with the professional for a subject of the referral opportunity (532). The method 520 includes automatically reserving at least one resource required for the appointment before the appointment (534).

Referring now to FIG. 5B in greater detail, and in connection with FIG. 2, the profile generator executing on the first computing device automatically generates a profile of a professional (522). In some embodiments, the profile generator automatically generates a profile as described above in reference to FIG. 3A.

An analysis engine executing on the first computing device receives from a second computing device an identification of a referral opportunity having at least one requirement (524). In some embodiments, the analysis engine 204 receives the identification of the referral as described above in reference to FIG. 3A.

The analysis engine determines that the generated profile satisfies the at least one requirement (526). In some embodiments, the analysis engine 204 determines that the generated profile satisfies the at least one requirement as described above in reference to FIG. 3A.

The analysis engine transmits to the second computing device the identification of the professional (528). In some embodiments, the analysis engine 204 transmits to the second computing device 102 the identification of the professional as set forth above in reference to FIG. 3A.

The first computing device receives an indication that a user of the second computing device made a referral to the professional (530). In some embodiments, the first computing device 106a receives the indication as set forth above in reference to FIG. 3A.

A workflow engine executing on the first computing device schedules an appointment with the professional for a subject of the referral opportunity (532). In some embodiments, the workflow engine 206 schedules the appointment with the professional as set forth above in reference to FIG. 5A.

The method 520 includes automatically reserving at least one resource required for the appointment before the appointment (534). In some embodiments, reserving the at least one resource involves reserving at least one room in which the appointment will occur. In some embodiments reserving the at least one resource involves reserving at least one item of equipment to be used during the appointment. In some embodiments reserving the at least one resource involves scheduling an additional professional to take part in the appointment. The workflow engine 206 may reserve a set of resources required for the appointment. In some embodiments, the workflow engine 206 determines the availability of each resource to be reserved as described above in reference to FIG. 5A. The workflow engine 206 in some embodiments transmits a request to reserve the at least one resource to a remote device 106b; for instance, the workflow engine 206 may transmit a request to reserve the at least one resource to a remote device 106b that maintains schedule information for the institution at which the professional works. In some embodiments, the workflow engine 206 provides a request to reserve the at least one resource to a person; for instance, the workflow engine 206 may send an email to a person responsible for scheduling the at least one resource.

In some embodiments, the workflow engine 206 may rank a plurality of resources, for a particular type of resource, and select the highest-ranking available resource. The workflow engine 206 may use any approach disclosed above for ranking profiles of professionals or entities in reference to FIG. 3A to rank the plurality of resources. The workflow engine 206 may rank the plurality of resources according to the preference of the professional. In some embodiments, the workflow engine 206 receives the preference of the professional from the professional. In some embodiments, the profile generator 202 maintains, in the professional's profile, data indicating the professional's preferences with regard to a type of resource. In some embodiments, the analysis engine 204 determines the likely preferences of the professional by analyzing past selections the professional made when deciding which resource of that resource type to use. In some embodiments, the profile generator 202 generates profiles for resources, as disclosed above in reference to FIG. 3. In some embodiments, the profile generator 202 maintains data in the profiles of resources indicating each resource's effectiveness. The effectiveness of a resource may be calculated using data concerning patient outcomes. The effectiveness of a resource may be calculated using feedback of professionals. The effectiveness of a resource may be calculated using patient feedback. The effectiveness of a resource may be calculated by determining the number of times the resource has been selected for the kind of appointment to be scheduled in the past. The effectiveness of a resource may be calculated by reference to information concerning its manufacture, where the resource is a piece of equipment; for instance, a piece of equipment that is newer may be ranked higher than an otherwise identical piece of equipment that is older. Where the resource is a professional, the resource may be ranked according to degree of expertise in a category of expertise relevant to the appointment to be scheduled.

In some embodiments, the workflow engine 206 ranks resources according to patient preferences. The workflow engine 206 may rank resources by logistical convenience to the subject of the referral; for instance, the workflow engine 206 may give a possible room in which the appointment will take place a higher ranking if it is closer to the home of the subject of the referral. Likewise, where the choice of resources is pertinent to the right of the subject of the referral to make informed choices concerning his or her treatment, the choice of one particular resource over another by the patient may cause the workflow engine 206 to give the preferred resource a higher ranking. In some embodiments, the workflow engine 206 receives information concerning the preferences of the subject of the referral from the referring professional, via the second computing device 102. In some embodiments, the workflow engine 206 receives information concerning the preferences of the subject of the referral from the subject of the referral, via a computing device (not shown) used by the subject of the referral.

In some embodiments, the workflow engine 206 ranks a plurality of possible combinations of resources with the professional. The workflow engine 206 may compare the patient outcomes of different combinations; by way of an example, if the professional is a surgeon, and the professional's patients have a higher rate of complication-free recovery when the professional works with a particular team of nurses, the combination of that professional with that team will be given a higher rank.

In one embodiment, therefore, the methods and systems described herein combine functionality for data-driven management of referrals between physicians with the ability to schedule appointments and reserve resources pursuant to those referrals. A physician using this system may not only select an appropriate professional for a referral, but also secure the appointment with that professional, and ensure that the patient receives the best resources available to assist the professional in providing care.

Although some of the examples provided herein describe the analysis in connection with the medical profession, the legal profession, and other professional service industries, one of ordinary skill in the art will understand that the methods and systems described herein are equally applicable in other industries. Similarly, although the description above categorizes professionals as industry professionals (such as providers of goods or services), professionals such as physicians, and employers of professionals, it should be understood that any one individual may be categorized as any one or more of these types of professionals; for example, an industry professional need not be a vendor but could be a physician seeking to provide an opportunity to another physician and an employer in a particular instance may be better categorized as an industry professional. As discussed in an example given above, a hiring manager in a business (e.g., an employer) may evaluate the behavior of a career development officer at an academic institution (e.g., an industry professional) to determine whether the career development officer is influential with graduating students (e.g., professionals) whom the business wishes to hire.

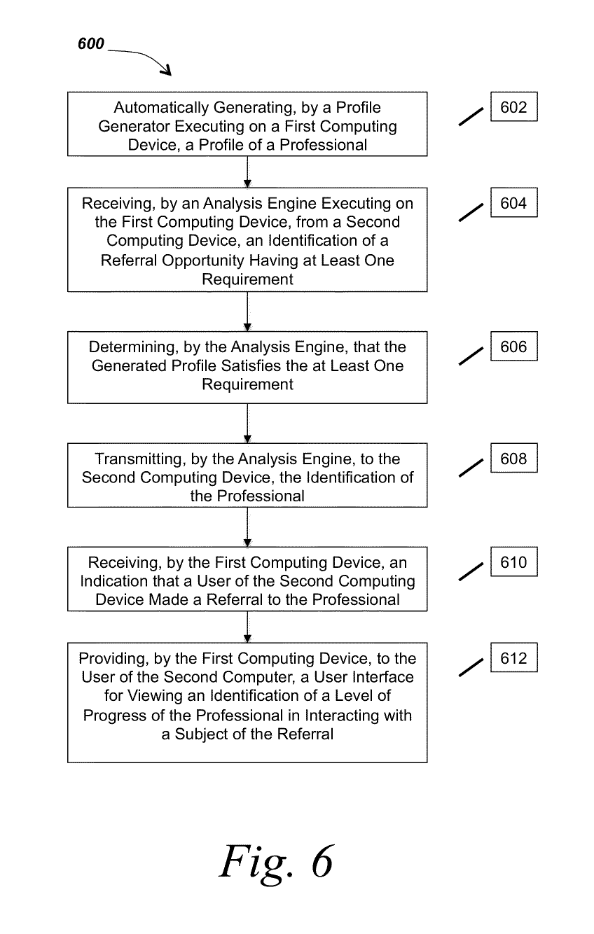

Referring now to FIG. 6, a flow diagram depicts one embodiment of a method 600 for case management by a referring professional. In brief overview, the method 600 includes automatically generating, by a profile generator executing on a first computing device, a profile of a professional (602). The method 600 includes receiving, by an analysis engine executing on the first computing device, from a second computing device, an identification of a referral opportunity having at least one requirement (604). The method 600 includes determining, by the analysis engine, that the generated profile satisfies the at least one requirement (606). The method 600 includes transmitting, by the analysis engine, to the second computing device, the identification of the professional (608). The method includes receiving, by the first computing device, an indication that a user of the second computing device made a referral to the professional (610). The method includes providing, by the first computing device, to the user of the second computing device, a user interface for viewing an identification of a level of progress of the professional in interacting with a subject of the referral (612).

Referring now to FIG. 6 in greater detail, and in connection with FIG. 2, the profile generator executing on the first computing device automatically generates a profile of a professional (602). In some embodiments, the profile generator 202 automatically generates a profile as described above in reference to FIG. 3A.

An analysis engine executing on the first computing device receives from a second computing device an identification of a referral opportunity having at least one requirement (604). In some embodiments, the analysis engine 204 receives the identification of the referral as described above in reference to FIG. 3A.

The analysis engine determines that the generated profile satisfies the at least one requirement (606). In some embodiments, the analysis engine 204 determines that the generated profile satisfies the at least one requirement as described above in reference to FIG. 3A.

The analysis engine transmits to the second computing device the identification of the professional (608). In some embodiments, the analysis engine 204 transmits to the second computing device 102 the identification of the professional as set forth above in reference to FIG. 3A.

The first computing device receives an indication that a user of the second computing device made a referral to the professional (610). In some embodiments, the first computing device 106a receives the indication as set forth above in reference to FIG. 3A.

The first computing device provides, to the user of the second computing device, a user interface for viewing an identification of a level of progress of the professional in interacting with a subject of the referral (612). The presentation engine 208 may provide the user interface 210 in the form of a web page that displays on the second computing device 102. The presentation engine 208 may provide the user interface 210 in the form of an application that executes on the second computing device 102. In some embodiments, the presentation engine 208 sends update messages to the second computing device 102 describing the level of progress. The user interface 210 in some embodiments receives requests from the referring professional for information concerning the level of progress, and provides updated information in response.

The method may include providing, by the first computing device, to the user of the second computing device, a user interface for viewing an identification of an action taken by the professional in interacting with a subject of the referral. In some embodiments the presentation engine 208 provides a user interface 210 for viewing an identification of an action taken by the professional in interacting with a subject of the referral. For example, and without limitation, the first computing device 106a may receive data indicating that a second professional is performing work under the supervision of the professional. A medical resident, for example, may perform a procedure pursuant to the referral, which would nonetheless be billed as performed by the referred professional.

The method may include providing, by the first computing device, to the user of the second computing device, a user interface for viewing an identification of a second referral made by the professional in interacting with a subject of the referral. In some embodiments, the presentation engine 208 provides to the user of the second computing device 102 a user interface 210 for viewing the identification of the second referral made by the professional in interacting with the subject of the referral. For instance, the referred professional may discover that work by an additional specialist is needed for the professional to perform the task required by the referral; as an example a surgical procedure might require the guidance of a computed tomography (CT) scan, as interpreted by a radiologist, before the surgeon can proceed. In some embodiments, the analysis engine 204 determines the identity of a professional who performed a particular procedure by analyzing electronic medical records. In some embodiments, the analysis engine 204 determines the identity of a professional who performed a particular procedure by analyzing payroll records. In some embodiments, the analysis engine 204 receives information from the professional who performed a particular procedure, indicating that professional's identity.

It should be understood that the systems described above may provide multiple ones of any or each of those components and these components may be provided on either a standalone machine or, in some embodiments, on multiple machines in a distributed system. The phrases ‘in one embodiment’, ‘in another embodiment’, and the like, generally mean the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices; firmware; programmable logic; hardware (e.g., integrated circuit chip; electronic devices; a computer-readable non-volatile storage unit; and non-volatile memory, such as semiconductor memory devices, including EPROM, EEPROM and flash memory devices); magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for providing, by a referral management system, dynamic scheduling of profiled professionals, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for matching a professional with a referral opportunity, the method comprising:
automatically generating, by a profile generator executing on a first computing device, a profile of a professional;
receiving, by an analysis engine executing on the first computing device, from a second computing device, an identification of a referral opportunity having at least one requirement;
determining, by the analysis engine, that the generated profile satisfies the at least one requirement;
transmitting, by the analysis engine, to the second computing device, the identification of the professional;
receiving, by the first computing device, an indication that a user of the second computing device made a referral to the professional; and
scheduling, by a workflow engine executing on the first computing device, an appointment with the professional for a subject of the referral opportunity.

2. The method of claim 1, wherein automatically generating further comprises accessing, by the profile generator, at least one third computing device to collect data concerning the professional.

3. The method of claim 2, wherein automatically generating further comprises:
analyzing, by the profile generator, accessed data to determine whether to include the accessed data in the profile.

4. The method of claim 3, wherein analyzing further comprises:
determining, by the profile generator, whether collected data is duplicative of data already in the profile.

5. The method of claim 3, wherein analyzing further comprises:
determining, by the profile generator, whether the collected data indicates that data already in the profile is obsolete.

6. The method of claim 3, wherein analyzing further comprises:
determining, by the profile generator, using the collected data, an area of domain expertise of the profiled professional; and
performing, by the profile generator, a search of a database providing additional data relating to the profiled professional, using the determined area of domain expertise.

7. The method of claim 1, wherein determining further comprises determining that the generated profile satisfies a clinical effectiveness requirement.

8. The method of claim 7, wherein determining that the generated profile satisfies a clinical effectiveness requirement further comprises:
determining, by the analysis engine, for a type of procedure, a total number of procedures performed by a plurality of professionals, the plurality including the profiled professional;
determining, by the analysis engine, a percentage of the total number of procedures performed by the profiled professional; and
determining, by the analysis engine, that the determined percentage for the profiled professional exceeds a threshold.

9. The method of claim 1, wherein determining further comprises determining that the generated profile satisfies a financial requirement.

10. The method of claim 1, wherein determining further comprises determining that the generated profile satisfies an operational requirement.

11. The method of claim 1, wherein determining further comprises verifying at least one credential associated with the professional.

12. The method of claim 1, wherein determining further comprises determining that the generated profile satisfies each of a plurality of requirements.

13. The method of claim 1, wherein scheduling further comprises determining an amount of time required by the professional for the appointment.

14. The method of claim 1, wherein scheduling further comprises determining that at least one resource required for the appointment is available.

15. The method of claim 1, wherein scheduling further comprises automatically reserving at least one resource required for the appointment before the appointment.

16. The method of claim 15, wherein reserving the at least one resource further comprises scheduling an additional professional to take part in the appointment.

17. The method of claim 15, wherein reserving the at least one resource further comprises transmitting a request to reserve the at least one resource to a remote device that maintains schedule information for an institution at which the professional works.

18. The method of claim 1, wherein determining further comprises:
ranking, by the analysis engine, a plurality of generated profiles; and
selecting, by the analysis engine, the highest-ranked generated profile.

19. A system for matching a professional with a referral opportunity, the system comprising:
a profile generator executing on a first computing device and automatically generating a profile of a professional;
an analysis engine executing on the first computing device, receiving, from a second computing device, an identification of a referral opportunity having at least one requirement, determining, by the analysis engine, that the generated profile satisfies the at least one requirement, and transmitting, by the analysis engine, to the second computing device, the identification of the professional;
a presentation engine, executing on the first computing device and receiving an indication that a user of the second computing device made a referral to the professional; and
a workflow engine executing on a third computing device and scheduling an appointment with the professional for a subject of the referral opportunity.

20. The system of claim 19, wherein the third computing device and the first computing device are the same device.
